(19) United States
(12) Patent Application Publication
(10) Pub. No.: US 2014/0365353 A1
(43) Pub. Date: Dec. 11, 2014

(54) MANAGEMENT OF PARTICIPATION OF MARKET PARTICIPANTS IN A FINANCIAL EXCHANGE

(71) Applicant: Rawllin International Inc., Tortola (VG)

(72) Inventor: Simon Shvarts, San Jose, CA (US)

(21) Appl. No.: 13/914,191

(22) Filed: Jun. 10, 2013

(51) Int. Cl. G06Q 40/02

(52) U.S. Cl. CPC G06Q 40/025
USPC 705/38

(57) ABSTRACT

Techniques for managing participation of market participants in a credit exchange and providing automated real-time approved financial offers to communication devices associated with users are presented. An open credit exchange platform (OCEP) includes a credit management component (CMC) that facilitates standardizing financial products to facilitate comparing financial offers from different market participants and identifying a preferred financial offer. CMC also notifies a market participant when its offer is selected by the CMC and/or consumer. CMC tracks performance of financial offers made to consumers by market participants via the OCEP relative to offers by other market participants, analyzes information relating to the tracked performance, and generates analytics feedback information based on the analyzed information. CMC communicates analytics feedback information to a market participant to enable the market participant to evaluate the performance of its financial products and modify its financial products to facilitate improving performance of its financial products.

### TECHNICAL FIELD

This disclosure relates generally to financial-related management, and, more specifically, to managing participation of market participants in a financial exchange in a communication network environment.

### BACKGROUND

Today, users (e.g., consumers) can use communication devices (e.g., computers, mobile phones, electronic tablets, etc.) to access many different types of information, including financial information, perform financial transactions, and/or perform a variety of other functions. For example, users can access their bank accounts or credit accounts online, can make payments to financial accounts or transfer money between financial accounts online, or can access or receive offers (e.g., product or service sale offers) for products or services via online sites, emails, or text messages, etc.

When making purchases of products or services, consumers often can rely on credit (e.g., monetary loans, credit line on a credit card or other financial account, etc.) in addition to or as an alternative to using money. Conventionally, in many instances, when desiring credit for use in purchasing a product (e.g., car, house, appliance, home-related product, etc.) or service (e.g., obtaining a line of credit or monetary loan, heating and air conditioning service, roofing service, etc.), a consumer can fill out a loan or credit application that can include the consumer's personal information (e.g., name, address, phone number, etc.), employment history, financial or credit history, a credit check authorization, and/or other information. The potential creditor can review the information provided by the consumer and/or can access the person's financial or credit history through a third-party service (e.g., a financial or credit history aggregator service, which also can provide a standardized credit score that can be indicative of the credit worthiness of the consumer). Based at least in part on the review of the information provided by the consumer and/or the person's financial or credit history obtained via a third-party service, the potential creditor can make a determination regarding whether to offer the desired credit to the consumer for the purchase of the product. If the potential creditor determines that the consumer is sufficiently creditworthy, the potential creditor may make an offer to extend credit to the consumer in relation to the purchase of the product.

### SUMMARY

The following presents a simplified summary of various aspects of the disclosed subject matter in order to provide a basic understanding of such aspects. This summary is not an extensive overview of all contemplated aspects, and is intended to neither identify key or critical elements nor delineate the scope of such aspects. Its sole purpose is to present some concepts of the disclosed subject matter in a simplified form as a prelude to the more detailed description that is presented later.

The disclosed subject matter can include a system that can comprise a memory to store computer-executable components; and a processor, coupled to the memory, that executes or facilitates execution of at least one of the computer-executable components, the computer-executable components. The computer-executable components comprising an open credit exchange component that is associated with a set of financial service provider identities and a set of consumer identities, and facilitates evaluation of a performance of a set of approved financial offers of a financial service provider identity of the set of financial service provider identities, wherein the set of approved financial offers are directed to one or more consumer identities of the set of identities. The computer-executable components also comprising a credit management component that generates performance analytics relating to the subset of approved financial offers of the financial service provider identity based at least in part on a result of the evaluation of the performance of the subset of approved financial offers, and presents analytics feedback information comprising information relating to the performance analytics associated with the subset of approved financial offers to a communication device or a destination address associated with the financial service provider identity.

The disclosed subject matter also can include a method comprising generating, by a system comprising a processor, financial-offer performance analytics relating to a set of pre-approved financial offers of a financial service provider identity based at least in part on a result of an evaluation of a performance of the set of pre-approved financial offers. The method also can comprise presenting, by the system, analytics feedback information comprising information relating to the financial-offer performance analytics associated with the set of pre-approved financial offers to a communication device or a destination address associated with the financial service provider identity

The disclosed subject matter further can comprise a computer-readable storage device storing computer-executable instructions that, in response to execution, cause a system comprising a processor to perform operations, comprising: generating financial-offer performance analytics relating to a set of approved financial offers of a financial service provider identity based at least in part on a result of an evaluation of a performance of the set of approved financial offers; and communicating analytics feedback information comprising information relating to the financial-offer performance analytics associated with the set of approved financial offers to a communication device or a destination address associated with the financial service provider identity

The following description and the annexed drawings set forth in detail certain illustrative aspects of the disclosed subject matter. These aspects are indicative, however, of but a few of the various ways in which the principles of the disclosed subject matter may be employed. The disclosed subject matter is intended to include all such aspects and their equivalents. Other advantages and distinctive features of the disclosed subject matter will become apparent from the following detailed description of the disclosed subject matter when considered in conjunction with the drawings.

### BRIEF DESCRIPTION OF THE DRAWINGS

FIG. 1 illustrates a block diagram of an example system that can facilitate managing participation of market participants in a credit exchange, providing (e.g., in real or near real time) analytics feedback information regarding respective financial offers of respective financial service providers, and providing (e.g., in real or near real time) automated real-time approved financial offers (e.g., a preferred approved financial offer(s)) to communication devices associated with users (e.g., consumers), in accordance with various aspects and embodiments described herein.

FIG. 2 depicts a block diagram of an example credit management component, in accordance with various aspects and embodiments of the disclosed subject matter.

FIG. 3 illustrates a block diagram of an example financial service provider (FSP) credit management component, in accordance with various aspects and embodiments of the disclosed subject matter.

FIG. 4 illustrates a block diagram of an example consumer finances management component in accordance with various aspects and embodiments of the disclosed subject matter.

FIG. 5 depicts a diagram of an example system that can facilitate managing participation of market participants in a credit exchange, providing (e.g., in real or near real time) analytics feedback information regarding respective financial offers of respective financial service providers, and providing (e.g., in real or near real time) automated real-time approved financial offers (e.g., a preferred approved financial offer(s)) to communication devices associated with users (e.g., consumers), in accordance with various aspects and embodiments described herein.

FIG. 6 illustrates a flow diagram of an example method that can facilitate presenting (e.g., in real or near real time) analytics feedback information relating to a subset of financial offers of a financial service provider to the financial service provider, in accordance with various aspects and embodiments of the disclosed subject matter.

FIG. 7 depicts a flow diagram of an example method that can facilitate standardizing a financial offer (e.g., an approved financial offer), in accordance with various aspects and embodiments of the disclosed subject matter.

FIG. 8 presents a flow diagram of an example method that can facilitate providing (e.g., in real or near real time) analytics feedback information relating to one or more financial offers of a financial service provider to the financial service provider, in accordance with various aspects and embodiments of the disclosed subject matter.

FIG. 9 is a flow diagram of an example method that can facilitate notifying (e.g., in real or near real time) a financial service provider of a change of status (e.g., ranking status) of its financial offer, in accordance with various aspects and embodiments of the disclosed subject matter.

FIG. 10 is a diagram of an example wireless communication device in accordance with various aspects and embodiments of the disclosed subject matter.

FIG. 11 is a schematic block diagram illustrating a suitable operating environment.

FIG. 12 is a schematic block diagram of a sample-computing environment.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

Today, consumers can use communication devices to access many different types of information, including financial information, perform financial transactions, and/or perform a variety of other functions. When making purchases of products or services, consumers often can rely on credit (e.g., monetary loans, credit line on a credit card or other financial account, etc.) in addition to or as an alternative to using money.

Conventionally, in many instances, when desiring credit for use in purchasing a product (e.g., car, house, appliance, home-related product, etc.) or service (e.g., obtaining a line of credit or monetary loan, heating and air conditioning service, roofing service, etc.), a consumer can fill out a loan or credit application that can include the consumer's personal information (e.g., name, address, phone number, etc.), employment history, financial or credit history, a credit check authorization, and/or other information. The potential creditor can review the information provided by the consumer and/or can access the person's financial or credit history through a third-party service (e.g., a financial or credit history aggregator service, which also can provide a standardized credit score that can be indicative of the credit worthiness of the consumer). Based at least in part on the review of the information provided by the consumer and/or the person's financial or credit history obtained via a third-party service, the potential creditor can make a determination regarding whether to offer the desired credit to the consumer for the purchase of the product. If the potential creditor determines that the consumer is sufficiently creditworthy, the potential creditor may make an offer to extend credit to the consumer in relation to the purchase of the product.

Conventional processes for offering of credit or other financial products to consumers, obtaining credit or other financial products by consumers, and managing the participation of market participants (e.g., financial service providers, such as creditors, lenders, etc.) in connection with offering credit or other financial products to consumers can be inefficient. For example, conventional processes for obtaining credit can be unnecessarily time consuming, as consumers may have to fill out a credit application and submit the application for approval before potentially receiving an approved financial offer or learning that they have not been approved for credit. Conventional processes for obtaining credit also can reduce the use of credit from a financial services provider by creditworthy consumers, as creditworthy consumers may not realize some credit opportunities available to them or may use other available financial resources (e.g., money from bank account, credit card from another financial services provider, etc.) to facilitate making purchases of products or services instead of using the financial services provider. Another deficiency can be that conventional processes for obtaining credit may reduce the purchase of products and services by creditworthy consumers, as creditworthy consumers may not realize some credit opportunities available to them to facilitate making purchases of products or services and, as a result, may not purchase such products or services thereby resulting in a reduction in product or service purchases.

Also, many traditional approaches and techniques relating to credit offers focus on the consumer side, rather than focusing on the side of the market participants (e.g., financial service providers). As a result, with regard to the market-participant side, there remains a number of deficiencies. For instance, often there can be different types of financial offerings from different financial service providers, and this can make it difficult to perform a meaningful comparison (e.g., an “apples-to-apples” comparison) of the different types of financial offerings to facilitate identifying which of the offers is the best offer for a consumer. Conventional processes for handling financial offerings from different financial service providers can fail to adequately account for the different types of financial offerings of different financial service providers and can result in failing to identify a best financial offer for a consumer. Conventional processes also can fail to adequately inform financial service providers about the performance or other aspects of the financial offers they make to consumers.

To that end, techniques for managing participation of market participants in a credit exchange, comprising an open credit exchange platform, providing (e.g., in real or near real time) analytics feedback information regarding respective financial offers of respective financial service providers, and providing (e.g., in real or near real time) automated real-time approved financial offers (e.g., a preferred approved financial offer(s)) to communication devices associated with users (e.g., consumers) are presented. An open credit exchange platform (also referred to as, e.g., an open credit exchange component) can be employed to facilitate managing the participation of market participants (e.g., financial service providers) in the credit exchange and providing automated real-time approved financial offers (e.g., a preferred approved financial offer(s)) to communication devices associated with users (e.g., consumers). The open credit exchange platform can be an always-on, always-updating platform that can operate to provide (e.g., automatically or dynamically provide) updated information (e.g., financial-related information) in real time, or at least near real time, to users (e.g., consumers, financial service providers, etc.) associated with the open credit exchange platform.

The open credit exchange platform can include a credit management component that can facilitate standardizing approved financial offers (e.g., pre-approved or unconditionally approved financial offers) and/or other financial products of different financial service providers to facilitate comparing approved financial offers and/or other financial products of different financial service providers and identifying a preferred approved financial offer and/or product. The credit management component can receive and/or collect various approved financial offers from various financial service providers associated with the open credit exchange platform, and can compare the approved financial offers to each other to identify an approved financial offer(s) that is most preferred (e.g., the best) relative to the other approved financial offers. The credit management component can present (e.g., in real time) the approved financial offer(s) to a user (e.g., consumer) for consideration by the user (e.g., to notify the user of a pre-approved line of credit available to the user that the user can consider accepting). The credit management component also can notify a financial service provider when its offer is selected (e.g., as a preferred approved financial offer) by the credit management component and/or accepted by a consumer (e.g., via a communication device of the consumer).

In some implementations, the credit management component can track (e.g., in real time) the performance of approved financial offers or other financial products made to consumers by respective financial service providers via the open credit exchange platform relative to offers by other financial service providers, analyze (e.g., in real time) information relating to the tracked performance of such offers or other products, and generate (e.g., in real time or at least near real time) analytics feedback information based on the analyzed information. The credit management component can communicate analytics feedback information (e.g., in real time or at least near real time) to a financial service provider to enable the financial service provider to evaluate the performance of its financial products and modify its financial products, as desired (e.g., as needed), to facilitate improving performance of its financial products.

The credit management component also can implement and enforce defined conditions or rules (e.g., registration and/or credit-exchange participation conditions or rules) that can regulate the registration and participation of financial service providers, including larger entities (e.g., banks, stores, etc.) and smaller entities (e.g., a person (e.g., a person participating in a peer-to-peer (P2) manner), small business, etc.), and other users (e.g., consumers, financial information providers, etc.) in the credit exchange. For example, the credit management component can implement and enforce defined conditions or rules relating to a minimum amount of capital (e.g., money or other assets) and/or a minimum amount of liquid assets an entity is required to have to qualify to be permitted to be a market participant (e.g., financial service provider) associated with the open credit exchange platform, a minimum amount of time that an entity has been engaged in the business of offering financial products or services in order to qualify to be permitted to be a market participant associated with the open credit exchange platform, a defined reputation (e.g., reputation score or assessment) that can demonstrate the entity has a sufficiently good reputation to qualify to be permitted to be a market participant associated with the open credit exchange platform, etc.

To facilitate enabling financial service providers to make informed decisions regarding the issuing of approved financial offers, the credit management component that can monitor and collect personal information, financial information, and/or consumer behavior information respectively associated with users (e.g., consumers), and/or other relevant information. The personal information, financial information, and/or consumer behavior information can include, for example, credit history of consumers (e.g., as reported by financial service providers associated with the open credit exchange platform, as reported by third-party credit reporting services, etc.), personal information (e.g., name, address, marital status, number of children, etc.) of consumers, employment history of consumers, consumer transaction history of consumers, assets and/or liabilities of consumers, social profile information associated with consumers (e.g., as provided to the open credit exchange platform by consumers, as obtained from a third-party social networking site, etc.), demographic information associated with consumers, etc. The credit management component can continue (e.g., continuously in real or near real time, periodically, dynamically, etc.) to monitor, collect, and/or update the personal information, financial information, consumer behavior information, and/or other relevant information.

The credit management component can analyze and/or classify the personal information, financial information, consumer behavior information, and/or other relevant information to facilitate providing analysis or classification results based at least in part on such information to financial service providers associated with the open credit exchange platform. In some implementations, the credit management component can provide raw data of the collected personal information, financial information, consumer behavior information, and/or other relevant information to financial service providers associated with the open credit exchange platform. The credit management component also can standardize data relating to the collected personal information, financial information, consumer behavior information, and/or other relevant information to facilitate presenting such information to the financial service providers. For example, the credit management component can process the collected personal information, financial information, consumer behavior information, and/or other relevant information to standardize or normalize such information to correspond to a defined N financial-related parameters associated with consumers to facilitate evaluation of the financial-related information by the financial service providers, and/or can generate respective financial health scores associated with respective consumers, as more fully disclosed herein. As part of the analysis or classification of such information, the credit management component also can verify respective pieces of information, assign accuracy confidence levels to respective pieces of information (e.g., rate the accuracy of a piece of information on a scale ranging from 0% to 100%), or otherwise provide an indication of the strength of the accuracy of respective pieces of data to facilitate enabling the financial service providers to understand the accuracy and reliability of the respective pieces of information and analyze the respective pieces of information accordingly.

As part of the always-on, always-updating features of the open credit exchange platform, the credit management component can continue to monitor (e.g., automatically or dynamically monitor (e.g., dynamically monitor in response to a detected financial event), monitor in real or near real time) information relating to consumers, such as a user (e.g., consumer). The credit management component can update or modify (e.g., automatically, dynamically, or in real or near real time) the respective financial health scores of respective consumers based at least in part on an evaluation of the monitored information and previous collected information, can store the updated or modified financial health scores of the respective consumers in respective user profiles of the users, and/or can make the updated or modified financial health scores of the respective users available to communication devices associated with the financial service providers and/or respective communication devices associated with the respective users.

Communication devices of financial service providers associated with (e.g., registered with, approved by, utilizing, etc.) the open credit exchange platform can access or receive information (e.g., personal information, financial information, consumer behavior information, and/or other relevant information; standardized or normalized information based at least in part on the personal information, financial information, consumer behavior information, and/or other relevant information; financial health scores of users; other financial-related information; etc.) from the open credit exchange platform. The communication devices of financial service providers can include or be associated with financial-service-provider (FSP) credit management components that can respectively analyze (e.g., in real or near real time) the information received from the open credit exchange platform (e.g., the credit management component of the open credit exchange platform) to facilitate respectively determining or identifying financial offers (e.g., approved credit offers) that the respective financial service providers desire to make to respective consumers associated with the received information.

An FSP credit management component of a financial service provider can generate approved (e.g., pre-approved, unconditionally approved) financial offers (e.g., instant lines of credit, instant loans, etc.) directed to respective users (e.g., consumers), based at least in part on the analysis of received information (e.g., personal information, financial information, consumer behavior information, and/or other relevant information; standardized or normalized information (e.g., N parameters) based at least in part on the personal information, financial information, consumer behavior information, and/or other relevant information; other financial-related information; etc.), and defined financial assessment criteria (e.g., defined financial risk criteria) of the financial service provider. In some implementations, the approved financial offers can be structured in a standardized form, in accordance with defined financial offer criteria (e.g., as specified by the credit management component of the open credit exchange platform), to facilitate providing standardized approved financial offers to consumers for an easy comparison by users (e.g., an “apples-to-apples” comparison rather than an “apples-to-oranges” comparison). The FSP credit management components of respective financial service providers can provide approved financial offers directed to respective users to the open credit exchange platform for further processing.

For each user, the credit management component of the open credit exchange platform can receive approved financial offers directed to the user (e.g., consumer) from one or more financial service providers associated with the open credit exchange platform, and can analyze or evaluate the approved financial offers. The credit management component can determine or identify one or more (e.g., the best the most preferred, or a subset of best or most preferred) approved financial offers of a set of approved financial offers directed to the user for presentation to the communication device or destination address associated with the user. The credit management component can transmit the one or more approved financial offers to the communication device of the user, for example, via a push notification operation (e.g., the credit management component automatically, dynamically, or periodically pushes approved financial offers to the communication device of the user) or a pull notification operation (e.g., the communication device automatically, dynamically, periodically, or in response to a request for the approved financial offers from the user of the communication device, requests approved financial offers from the credit management component).

The communication device (e.g., computer, mobile phone, electronic tablet, etc.) of the user can receive the one or more (e.g., the best or most preferred, or a subset of best or most preferred) approved financial offers from the credit management component. If the user decides to accept an approved financial offer, the user can use the user's communication device to enter the user's electronic signature on a contract (e.g., electronic contract document) relating to the approved financial offer. The open credit exchange platform can verify the user's electronic signature to facilitate creating a legally binding contract relating to the approved financial offer. The monetary funds or credit associated with the approved financial offer can be applied or deposited (e.g., automatically or instantaneously applied or deposited) to a financial account or financial transaction associated with the user. As a result, the user can be provided the financial benefit (e.g., monetary credit and associated financial conditions) associated with the approved financial offer (e.g., in relation to the purchase of a product or service), and the financial service provider can be provided the financial benefit (e.g., interest and fees relating to the extension of credit) per the legally binding contract. Further, it is not necessary for the user to prepare and submit a credit or loan application for consideration and approval by a financial service provider, since the financial offer presented to the user has already been approved by the financial service provider based at least in part on the information previously made available to the financial service provider by the open credit exchange platform and the defined financial assessment criteria of the financial service provider.

In accordance with various aspects, the open credit exchange platform can facilitate securing data, and protecting the privacy of users associated with the open credit exchange platform. In some implementations, the credit management component can expose information relating to consumers in an anonymous manner to financial service providers, so that the financial service providers are not able to identify a consumer, but rather are able to view financial-related information associated with the consumer. For example, the financial-related information can be associated with a consumer identification number or name (e.g., a pseudo number or name) to facilitate obscuring the consumer's actual name from the financial service providers. In certain implementations, the credit management component can enable a consumer, using the consumer's communication device, to control the information (e.g., control the type or amount of information) of the consumer that is exposed to (e.g., made available to) financial service providers associated with the open credit exchange platform. The credit management component and/or the consumer's communication device (e.g., via a financial application used by the communication device) can provide for transparency of the data by enabling the consumer to perceive and know which information of the consumer is being exposed to the financial service providers. The credit management component and the consumer's communication device (e.g., via the financial application) can employ an authentication protocol(s) or algorithm(s) to further facilitate securing data and financial transactions associated with the consumer in relation to the open credit exchange platform.

These aspects and other aspects of the disclosed subject matter are further described in relation to the drawings.

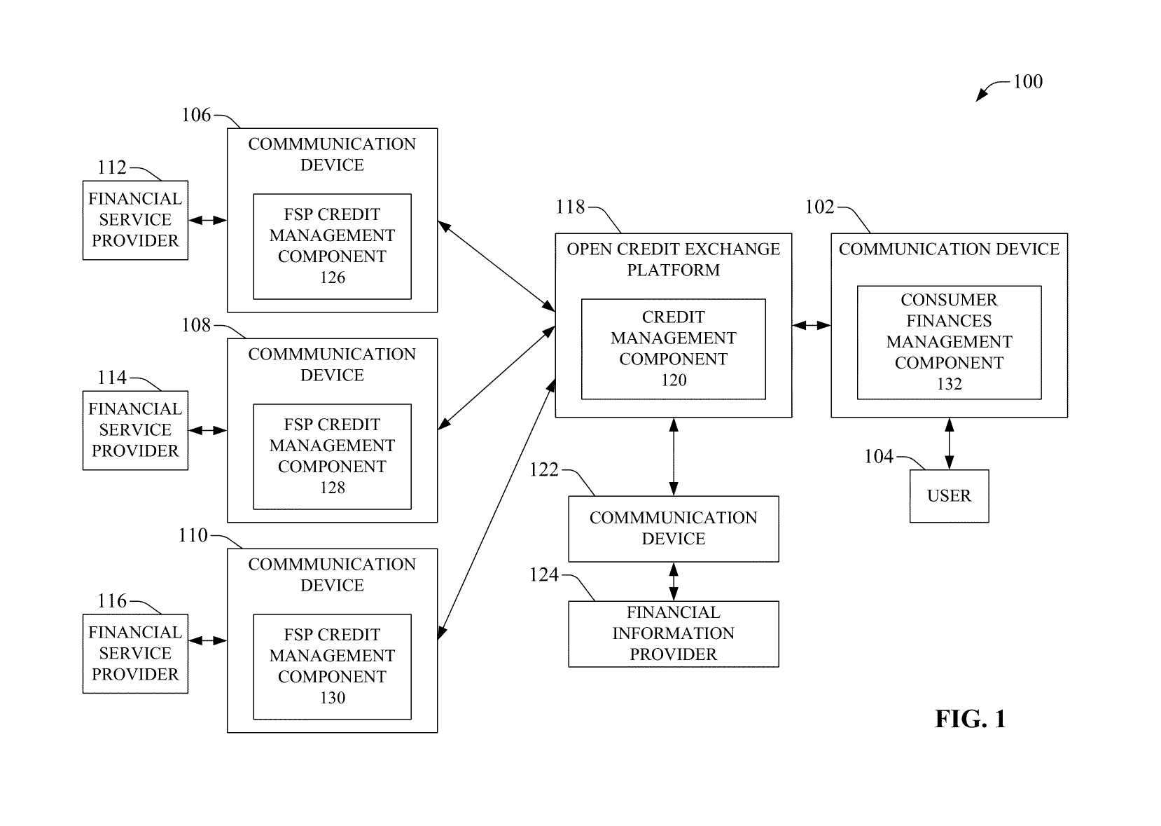

FIG. 1 illustrates a block diagram of an example system 100 that can facilitate managing participation of market participants in a credit exchange, providing (e.g., in real or near real time) analytics feedback information regarding respective financial offers of respective financial service providers, and providing (e.g., in real or near real time) automated real-time approved financial offers (e.g., a preferred approved financial offer(s)) to communication devices associated with users (e.g., consumers), in accordance with various aspects and embodiments described herein. In an aspect, the system 100 can include a communication device 102 that can be associated with a user 104 (e.g., consumer). The communication device 102 can be, for example, a computer, a mobile or wireless communication device (e.g., a mobile phone and/or smart phone), an electronic tablet, pad, or notebook, an electronic gaming device, a set-top box, a personal digital assistant (PDA), etc.

The system 100 also can include a plurality of other communication devices, including communication device 106, communication device 108, and communication device 110, that can be respectively associated with a plurality of financial service providers, including financial service provider 112, financial service provider 114, and financial service provider 116. The financial service providers (e.g., 112, 114, 116) can be banks, lenders, stores, product or service providers that also provide financial services, peers (e.g., for peer-to-peer (P2P) approved financial offers from one user (e.g., peer) to another user (e.g. peer)), or other entities. The financial service providers (e.g., 112, 114, 116) can be, for example, brick-and-mortar entities, or online or virtual entities. As part of their business, the financial service providers (e.g., 112, 114, 116) can lend money to users, maintain financial accounts (e.g., bank account, credit account, etc.) for users, extend credit (e.g., via a credit card account, credit line, etc.) to users, and/or provide other types of financial products or services to users. In some instances, the financial service providers (e.g., 112, 114, 116) can provide the financial services (e.g., money loan, extension of credit, etc.) in relation to the purchase of products (e.g., car, television, computer, electronic pad or tablet, phone, household appliances, etc.) or services (e.g., vacation or travel-related services, home repair or renovation services, etc.) from the financial service provider or a third-party product or service provider.

The system 100 can comprise an open credit exchange platform 118 (also referred to herein as, e.g., an open credit exchange component) that can facilitate managing participation of market participants (e.g., financial service providers) in a credit exchange associated with the open credit exchange platform 118. The open credit exchange platform 118 also can facilitate generating or selecting financial offers (e.g., approved financial offers) and providing financial offers to communication devices, such as communication device 102, associated with users (e.g., consumers), such as user 104, in accordance with defined financial offer criteria.

At various times, the open credit exchange platform 118 can be associated with (e.g., communicatively connected to) communication device 102 to facilitate receiving information from the communication device 102 (e.g., information provided by the user 104 via the communication device 102), providing notifications of approved financial offers to the communication device 102, or providing other information to the communication device 102, etc. At various times, the open credit exchange platform 118 also can be associated with (e.g., communicatively connected to) communication device 106, communication device 108, and communication device 110 to facilitate providing information relating to consumers to the communication device 106, communication device 108, and communication device 110, receiving approved financial offers directed to users (e.g., 104) or other information from the communication device 106, communication device 108, and communication device 110, etc. The open credit exchange platform 118 can be an always-on, always-updating platform that can operate to provide updated information (e.g., financial-related information, approved financial offers, etc.) in real time to users (e.g., consumers, financial service providers, etc.) via their respective communication devices (e.g., communication devices 102, 106, 108, 110, etc.) associated with the open credit exchange platform 118.

The open credit exchange platform 118 can comprise a credit management component 120 that can control operations associated with the open credit exchange platform 118. The credit management component 120 also can facilitate managing the participation of financial service providers (e.g., 112, 114, 116) associated with the open credit exchange platform 118, implementing and enforcing defined conditions or rules for regulating the participation of financial service providers or other users (e.g., consumer, financial information provider 124, etc.) in the credit exchange, standardizing approved financial offers (e.g., pre-approved or unconditionally approved financial offers) and/or other financial products of different financial service providers (e.g., 112, 114, 116), etc., as more fully disclosed herein. The credit management component 120 further can control providing information to financial service providers (e.g., 112, 114, 116) via respective communication devices (e.g., 106, 108, 110) to facilitate generation of approved financial offers by the financial service providers, processing of approved financial offers and other information received from the financial service providers or other entities, selecting of one or more (e.g., the best or most preferred, or a subset of best or most preferred) approved financial offers in relation to a user (e.g., 104), etc., as more fully disclosed herein.

In some implementations, the open credit exchange platform 118 can be associated with (e.g., communicatively connected to) a communication device 122 that can be associated with a financial information provider 124. The financial information provider 124 can be an entity in the business of collecting, analyzing, and processing financial data relating to consumers (e.g., user 104), and/or demographic information relating to consumers.

For example, the financial information provider 124 can be a consumer reporting company that can generate and maintain credit reports, financial histories, and/or financial scores (e.g., credit scores), wherein the financial information provider 124 can provide such credit reports, financial histories, and/or financial scores to other entities (e.g., the open credit exchange platform 118, financial service provider 112, financial service provider 114, financial service provider 116, user 104, etc.), for example, when such other entities are authorized or entitled to obtain such information. A financial information provider 124 also can be a store (e.g., online store, brick-and-mortar store, etc.) or another user (e.g., another user who has engaged in a financial transaction associated with the user 104 or provides other financial-related information associated with the user 104).

The credit management component 120 can use the financial information received from the financial information provider 124 via the communication device 122 to facilitate providing such financial information or information relating thereto (e.g., processed or synthesized information based on such financial information) to the financial service providers 112, 114, and 116 via communication devices 106, 108, and 110, or to the user 104 via communication device 102, or processing (e.g., analyzing, evaluating, etc.) such financial information to facilitate generating information for use in making financial offers, financial decisions, etc.

In some implementations, the credit management component 120 can facilitate standardizing approved financial offers (e.g., pre-approved or unconditionally approved financial offers) and/or other financial products created and/or issued by different financial service providers (e.g., 112, 114, 116) to facilitate comparing approved financial offers and/or other financial products of different financial service providers and identifying a preferred approved financial offer(s) and/or product(s) for respective consumers (e.g., user 104). For instance, conventionally, different financial service providers can use different financial offer language, financial offer terms or provisions, contract language, etc., in structuring their respective financial offers (e.g., financial credit offers, such as a loan or line of credit). This can make it difficult to compare different financial offers from different financial providers in a meaningful and accurate way (e.g., to make an “apples-to-apples” comparison of the different offers). The credit management component 120 can standardize the approved financial offers or other financial products of respective financial service providers (e.g., 112, 114, 116) to enable the credit management component 120 to perform an accurate, statistically relevant comparison of the approved financial offers or other financial products presented by the respective financial service providers (e.g., 112, 114, 116) via the open credit exchange platform 118. The credit management component 120 also can standardize contracts associated with approved financial offers or other products of different financial service providers (e.g., 112, 114, 116) such that contract language, contract provisions, and other aspects of a contract between a financial service provider and a consumer can be standardized.

To facilitate standardizing approved financial offers or products, and associated contracts, the credit management component 120 can present standardized financial offer or product parameters to communication devices (e.g., 106, 108, 110) of respective financial service providers (e.g., 112, 114, 116) to facilitate the generation of standardized approved financial services or other standardized financial products by the respective financial service providers via the open credit exchange platform 118, wherein the standardized approved financial services or products can be offered to consumers (e.g., user 104) associated with the open credit exchange platform 118. For example, the credit management component 120 can present standardized offer parameters using one or more lists or menus, comprising the available standardized offer parameters, from which financial service providers (e.g., 112, 114, 116) can select desired parameters using their respective communication devices (e.g., 106, 108, 110). The standardized offer parameters can comprise, for example, one or more defined time-related terms of a loan (e.g., for mortgage loans, the terms can comprise, for example, 30 years or 15 years, or another desired loan period(s); for automobile loans, the terms can comprise, for example, 4, 4.5, 5, 5.5, or 6 years, or another desired loan period(s); for other types of loans, the terms can comprise, for example, 3, 3.5, 4, 4.5, or 5 years, or another desired loan period(s); etc.), one or more defined prepayment terms, one or more down payment terms (e.g., 5%, 10%, or 20% down payment; a defined amount (e.g., $500, $1000, etc.) required as a down payment; etc.), one or more defined interest rates (e.g., 2.0%, 2.5%, 3.0%, or another desired interest rate(s)), one or more defined monthly payments, one or more defined same-as-cash time periods (e.g., 90 days same as cash, 6 months same as cash, 1 year same as cash, or other desired same-as-cash time period), and/or other financial offer terms associated with a loan or line of credit. In some implementations, to facilitate standardizing approved financial offers, the credit management component 120 will only allow the financial service providers (e.g., 112, 114, 116) to select from the standardized offer parameters made available to the communication devices (e.g., 106, 108, 110) of the financial service providers via the selections, lists, or menus provided by the credit management component 120.

Thus, for example, if financial service provider 112 typically offers mortgage loans that have repayment periods that span 20 years or 30 years with no mortgage loans having a 15-year repayment period, but the credit management component 120 presents standardized offer parameters of 15 years and 30 years for repayment periods for mortgage loans in accordance with a defined financial offer criterion(s), the financial service provider 112 will not be able to issue an approved financial offer for a mortgage loan with a 20-year repayment period. Per this example, via the open credit exchange platform 118, the financial service provider 112 can still select the standardized financial offer parameter of 30 years for a loan repayment period and generate an approved financial offer (e.g., standardized approved financial offer) for a mortgage loan with a repayment period of 30 years, and/or can modify its business practices to offer 15-year mortgages and select the standardized financial offer parameter of 15 years for a loan repayment period and generate an approved financial offer for a mortgage loan with a repayment period of 15 years.

As another example, a financial service provider (e.g., 114) may typically offer mortgage loans that allow for automatic bi-weekly loan payments, instead of automatic monthly loan payments, that can enable a 30-year mortgage loan to be paid off in a significantly shorter time than 30 years. If the open credit exchange platform 118 includes automatic bi-weekly loan payments as a standardized financial offer parameter for mortgage loan payments, in accordance with a defined financial offer criterion, the credit management component 120 can permit the financial service provider to include that standardized financial offer parameter as part of an approved financial offer. If, in accordance with a defined financial offer criterion, the open credit exchange platform 118 does not include automatic bi-weekly loan payments as a standardized financial offer parameter for mortgage loan payments, the credit management component 120 will not allow the financial service provider (e.g., 114) to include automatic bi-weekly loan payments as part of an approved financial offer.

It is to be appreciated and understood that other or additional desired standardized offer parameters can be made available by the credit management component 120 to communication devices (e.g., 106, 108, 110) of financial service providers (e.g., 112, 114, 116), in accordance with a defined financial offer criterion(s). For example, with regard to mortgage loans, it can be desirable to include standardized financial offer parameters for adjustable-rate mortgage loans or interest-only mortgage loans, and, as desired (e.g., when in accordance with a defined financial offer criterion(s)), the credit management component 120 can make one or more standardized financial offer parameters available to enable financial service providers to structure standardized approved financial offers for mortgages to include provisions for an adjustable-rate mortgage and/or an interest-only mortgage loan. Also, in some implementations, the credit management component 120 can facilitate standardizing of approved financial offers by having a first subset of terms of an offer that can conform to the standardized financial offer parameters made available to the financial service providers (e.g., 112, 114, 116), while allowing a second subset of terms of the offer to comprise another financial offer parameter(s) (e.g., a free form or non-standardized parameter) that is desired by the financial service provider creating the approved financial offer.

In some implementations, the credit management component 120 can classify and/or compare respective approved financial offers of respective financial service providers based at least in part on a subset of financial offer terms (e.g., standardized offer parameters). For example, the credit management component 120 can classify approved financial offers of different financial service providers (e.g., 112, 114, 116) that have the subset of financial offer terms in common (e.g., a same standardized loan repayment term, a same standardized down payment term, and/or a same standardized interest rate term for the loan) as being similar offers with regard to offer terms and/or can compare those approved financial offers against each other to facilitate determining a preferred approved financial offer from those approved financial offers.

In some implementations, the credit management component 120 can use an iterative process to facilitate standardizing or classifying approved financial offers, or defining standard approved financial offers. For example, on the front end (e.g., during the offer generation process) or on the back end (e.g., classifying offers received from financial service providers), the credit management component 120 can hold a subset of financial offer parameters fixed (e.g., for mortgage loan offer, hold the term of loan fixed to a certain length of time, hold down payment term fixed to a specified amount, etc.), while allowing a financial service provider to vary another subset of financial offer parameters (e.g., interest rate for the loan), to facilitate defining or classifying the offer, and iterate over other fixed financial offer parameters (e.g., make the interest rate of the loan fixed) while allowing other parameters (e.g., the term of the loan) to be varied (e.g., by financial service providers) to facilitate defining or classifying the offers.

As desired (e.g., when in accordance with a defined financial offer criterion(s)), the credit management component 120 also can compare approved financial offers that have one or more standardized financial offer terms that are different from each other (e.g., have one or more differing standardized financial offer parameters) to facilitate determining a preferred approved financial offer from those approved financial offers. For instance, the credit management component 120 can apply respective weights to respective standardized offer parameters to facilitate determining a preferred approved financial offer among approved financial offers based at least in part on defined financial offer criterion(s), respective preferences of respective users (e.g., consumers), and/or other factors. For example, a user preference of a consumer or a defined financial offer criterion can specify that 30-year mortgage loans are preferred over 15-year mortgage loans for real estate purchases, and the credit management component 120 can apply a higher weight or score to a 30-year mortgage loan term of one approved financial offer being made to the consumer by a financial service provider than a weight or score that it applies to a 15-year mortgage loan term of another approved financial offer being made to that consumer (e.g., by a same or different financial service provider) to facilitate generating (e.g., calculating) respective financial offer scores for the respective approved financial offers to facilitate determining a preferred approved financial offer from those and/or other approved financial offers.

In some implementations, while a financial service provider (e.g., 112) is creating an approved financial offer to offer to a particular consumer or to a group of consumers (e.g., credit or financial group of consumers) that meet a certain defined financial risk criterion(s) (e.g., satisfy a threshold financial health score or other financial or credit risk criterion(s)), the credit management component 120 can enable a financial service provider (e.g., 112), via its communication device (e.g., 106), to view (e.g., in real time or at least near real time) one or more approved financial offers of one or more other financial service providers (e.g., 114 and/or 116) that have been provided to the open credit exchange platform 118 for presentation, or at least to be considered by the open credit exchange platform 118 for presentation, to that consumer or group of consumers. The financial service provider (e.g., 112) can tailor its approved financial offer to that consumer or group of consumers so that its approved financial offer is better or more preferable (e.g., has a higher financial offer score) than the one or more approved financial offers of the competing financial service provider(s) (e.g., 114 and/or 116). For example, if financial service provider 114 has created an approved financial offer that offers a $20,000 loan for a car with an interest rate of 3.5% and a repayment period of 4 years in connection with a consumer(s) or credit group (e.g., group of consumers that satisfy a defined set of financial risk criteria (e.g., group of consumers that satisfy a threshold financial health score or other financial or credit risk criterion(s))), as desired, the financial service provider 112 can structure its approved financial offer to offer a $20,000 loan for a car with a lower interest rate (e.g., 3.25%) and a repayment period of 4 years to that consumer(s) or credit group (e.g., provided that doing so is in accordance the financial risk assessment performed by the financial service provider 112 in connection with that offer). Also, the open credit exchange platform 118, in part by providing information regarding the competitiveness (e.g., offer price), quality, or value (e.g., overall value taking all factors into account) of the respective offers or potential offers of respective financial service providers, can enable financial service providers to know how competitive their respective financial offers are against the offers of other financial providers. This can facilitate enabling financial service providers to operate more efficiently by not unnecessarily using resources (e.g., computing resources, time, etc.) to create financial offers that have a relatively low likelihood of being selected as a preferred approved financial offer by the credit management component 120 or accepted by consumers.

In response to receiving a new approved financial offer from or via use of a communication device (e.g., via communication device 106 accessing the open credit exchange platform 118 to generate the approved financial offer) from a financial service provider (e.g., 112) to offer to a particular consumer or to a group of consumers (e.g., credit group) that meet defined financial risk criteria of that financial service provider, the credit management component 120 can compare the terms of the new approved financial offer against an approved financial offer of another financial service provider (e.g., 114) in connection with that consumer or group of consumers to facilitate determining which of those offers is the preferred approved financial offer. If the credit management component 120 determines that the new approved financial offer is the preferred approved financial offer (e.g., better offer, offer having a higher financial offer score) over the approved financial offer of the other financial service provider (e.g., 114), in response to such determination, the credit management component 120 can notify (e.g., in real time or at least near real time) a financial service provider (e.g., 114) that has made an approved financial offer in connection with that consumer or group of consumers that its offer has been bettered by another (e.g., new) approved financial offer (e.g., the new offer of financial service provider 112). For instance, the credit management component 120 can generate a notification message and can transmit that notification message to the communication device 108 and/or destination address (e.g., email address or other electronic message box, phone number (e.g., via instant message)) associated with the financial service provider 114, wherein the notification message can comprise information that can facilitate notifying the financial service provider 114 that another offer (e.g., the approved financial offer of financial service provider 112) is more preferred than its approved financial offer and is the current preferred approved financial offer, can provide the terms of the current preferred approved financial offer, can provide a suggestion regarding how to modify its approved financial offer to make it more preferred than the current preferred approved offer, can provide a link (e.g., hyperlink) that can be selected to access the open credit exchange platform 118 to modify its offer, and/or can provide other information. This analytic (e.g., comparing an existing approved financial offer of a financial service provider 114 to a new approved financial offer of another financial service provider 112 to facilitate determining how the existing offer is performing relative to the new offer) is just one type of analytic that the credit management component 120 can perform, the feedback information provided in the notification message includes just some of the feedback features (e.g., performance feedback features or mechanisms) that the credit management component 120 can generate and/or provide (e.g., to financial service providers), and other analytics and feedback information features are disclosed herein.

As disclosed above and as more fully disclosed herein, the credit management component 120 can receive and/or collect various approved financial offers from various financial service providers (e.g., 112, 114, and/or 116) associated with the open credit exchange platform 118, and can compare the approved financial offers to each other to determine or identify an approved financial offer(s) that is most preferred (e.g., the best, having the highest financial offer score) relative to the other approved financial offers. The credit management component 120 can present (e.g., in real time or at least near real time) the approved financial offer(s) to a user (e.g., consumer) for consideration by the user (e.g., to notify the user of a pre-approved line of credit available to the user that the user can consider accepting). For example, the credit management component 120 can generate an offer notification message, comprising information regarding the preferred approved financial offer, and can transmit the offer notification message (e.g., in real time or at least near real time) to the communication device 102 and/or destination address (e.g., email address or other electronic message box (e.g., associated with a social networking site), electronic message box or electronic account associated with a digital wallet, phone number (e.g., via instant message)) associated with the consumer (e.g., user 104) to facilitate notifying the consumer of the preferred approved financial offer. If subsequently the credit management component 120 determines that another approved financial offer betters a then current preferred approved financial offer in connection with the consumer, the credit management component 120 can generate a new notification message or modify the contents (e.g., the available amount of monetary credit) of the digital wallet of the consumer to facilitate notifying the consumer of the new preferred approved financial offer and/or enabling the consumer to know the consumer's current available amount of credit (e.g., when the consumer “opens” (e.g., accesses) the consumer's digital wallet via the communication device 102).

In accordance with other features of the analytics and feedback mechanisms of the disclosed subject matter, in response to determining that an approved financial offer of a financial service provider (e.g., 112) is a preferred approved financial offer in connection with a consumer(s), the credit management component 120 can generate a notification message, and can transmit the notification message (e.g., in real time or at least near real time) to the communication device (e.g., 106) or destination address associated with the financial service provider (e.g., 112) to facilitate notifying the financial service provider (e.g., 112) that its offer has been selected as a preferred approved financial offer by the open credit exchange platform 118 in connection with that consumer(s). If an approved financial offer of a financial service provider (e.g., 112) is accepted by a consumer (e.g., via use of the communication device 102 to access the open credit exchange platform 118 to accept the offer), the credit management component 120 can generate a notification message, and can transmit the notification message (e.g., in real time or at least near real time) to the communication device (e.g., 106) or destination address associated with the financial service provider (e.g., 112) to facilitate notifying the financial service provider (e.g., 112) that its offer has been accepted by a consumer (e.g., via a communication device 102 of the consumer).

In accordance with still other features of the analytics and feedback mechanisms of the disclosed subject matter, the credit management component 120 can track (e.g., in real time or at least near real time) the performance of approved financial offers or other financial products made to consumers by respective financial service providers (e.g., 112, 114, 116) via the open credit exchange platform 118 relative to same or similar offers of other financial service providers (e.g., other of financial service providers, 112, 114, and/or 116), and/or relative to various credit or offer groups, to facilitate determining analytics (e.g., performance analytics) that can identify the performance of the approved financial offers or other financial products of a financial service provider relative to same or similar offers of other financial service providers and/or relative to various credit or offer groups. The various credit or offer groups can be, represent, or be associated with respective groups of consumers, wherein different groups of consumers can be associated with different ranges of financial health ranges or different ranges of financial risk, such as, for example, a first group of consumers that can comprise consumers that each have financial health scores that are determined to meet the criterion(s) (e.g., financial risk criterion(s)) or threshold to be identified as excellent, and a second group of consumers that can comprise consumers that each have financial health scores that are determined to meet the criterion(s) or threshold(s) (e.g., a threshold financial score range) to be identified as good (e.g., below excellent, but better than poor). The credit management component 120 can analyze (e.g., in real time or at least near real time) information relating to the tracked performance of such offers or other products in relation to the offers or other products of other financial service providers. For instance, the credit management component 120 can analyze how various approved financial offers of a financial service provider 112 have performed relative to that of other financial service providers (e.g., 114, 116, etc.), identify respective offer terms of the offers of the financial service providers, analyze the offer terms (e.g., financial offer parameters) of offers of the financial service provider 112 that have underperformed (e.g., not been selected as a preferred approved financial offer, not been accepted by a consumer, etc.) relative to the offer terms of offers of other financial service providers that have performed better (e.g., been selected as a preferred approved financial offer, been accepted by a consumer, etc.) to facilitate determining which terms of offers of the financial service provider 112 have been causing or at least likely have been causing such offers to underperform, analyze the offer terms (e.g., financial offer parameters) of offers of the financial service provider 112 that have performed relatively well (e.g., been selected as a preferred approved financial offer, been accepted by a consumer, etc.) relative to the offer terms of other financial offers of other financial service providers (e.g., 114, 116, etc.) to facilitate determining which offer terms of offers of the financial service provider 112 are responsible or at least likely responsible for such offers performing well, etc.

Based at least in part on the results of the analysis, the credit management component 120 can determine which offer terms (e.g., standardized or other financial offer parameters) of certain offers of the financial service provider 112 have been causing or at least potentially have been causing those certain offers to underperform, determine which terms of the certain other offers are responsible or at least potentially responsible for those certain other offers of the financial service provider 112 performing well, determine one or more offer modifications (e.g., modification of terms of offers) that can be made to any underperforming offers to facilitate improving any underperforming offers, generate analytics (e.g., performance analytics) that can provide detailed information regarding the performance of approved financial offers of the financial service provider 112, etc. The credit management component 120 can generate analytics feedback information, comprising the analytics, based at least in part on the results of the analysis. The analytics feedback information can include, for example, information identifying the number of offers made by the financial service provider 112 (e.g., over a defined time period), information identifying the number of offers selected as preferred by the credit management component 120 (e.g., over a defined time period), information identifying the number of offers accepted by a consumer(s) (e.g., over a defined time period), information identifying those terms of certain offers of the financial service provider 112 that have determined to be causing or at least potentially be causing those certain offers to underperform, information identifying those terms of certain other offers that have been determined to be responsible or at least potentially be responsible for those certain other offers of the financial service provider 112 performing relatively well, information identifying the one or more offer modifications (e.g., modification of terms of offers) that can be made to underperforming offers to facilitate improving those underperforming offers, etc.

In some implementations, the credit management component 120 can generate respective graphs, charts, tables, gauges, meters, etc., based at least in part on the analytics associated with a financial service provider (e.g., 112), to facilitate enabling the financial service provider to more easily interpret and understand the analytics feedback information. For example, the credit management component 120 can generate and present a set of online graphs, charts, tables, dashboard with gauges, meters, etc., that can be representative (e.g., be a visual representation) of the analytics feedback information (e.g., be representative of how the offers or products of the financial service provider are performing), and/or one or more modification controls (e.g., buttons, knobs, etc.) that can facilitate modifying offer parameters (e.g., standardized financial offer parameters) to present predicted performance of modified offers comprising the modified offer parameters (e.g., as predicted by the credit management component 120). The credit management component 120 can generate the analytics feedback information and present the analytics feedback information (e.g., as represented by the graphs, charts, tables, etc.) in real or at least near real time to a communication device (e.g., 106) of a financial service provider (e.g., 112) and/or as a notification (e.g., via a notification message sent to the communication device or destination address associated with the financial service provider) to facilitate providing information, to the financial service provider (e.g., 112), regarding how its offers have performed relative to same or similar offers of other financial service providers (e.g., other financial service providers 114, 116, etc.), and/or relative to various credit or offer groups.

The analytics feedback information (e.g., as represented by the graphs, charts, tables, etc.) and/or modification controls can facilitate assisting financial service providers (e.g., 112, 114, 116) to improve (e.g., enhance, optimize, maximize, etc.) the outcome of their respective financial service offers or products, in part, by facilitating ensuring that their respective offers or products remain competitive relative to the offers of products of other financial service providers. For instance, the analytics feedback information and/or the modification controls can facilitate enabling a financial service provider (e.g., 112) to evaluate the performance of its financial offer(s) or product(s) and modify its financial offer(s) or product(s), as desired (e.g., as needed), to facilitate improving performance of its financial offer(s) or product(s).

The credit management component 120 also can implement and enforce a set of defined conditions or rules (e.g., registration and/or credit-exchange participation conditions or rules) that can regulate the participation of financial service providers (e.g., 112, 114, 116), including larger entities (e.g., banks, stores, etc.) and smaller entities (e.g., a person (e.g., a person participating in a P2P manner), small business, etc.), in the credit exchange associated with the open credit exchange platform 118. For instance, the credit management component 120 can implement and enforce a set of defined conditions or rules relating to a minimum amount of capital (e.g., money or other assets) and/or a minimum amount of liquid assets that an entity is required to have to qualify to be permitted to be a market participant (e.g., financial service provider) associated with the open credit exchange platform 118, a minimum amount of time that an entity has been engaged in the business of offering financial products or services in order to qualify to be permitted to be a market participant associated with the open credit exchange platform 118, a defined reputation (e.g., reputation score or assessment) that can demonstrate the entity has a sufficiently good reputation to qualify to be permitted to be a market participant associated with the open credit exchange platform 118, and/or other specifications (e.g., requirements) for determining whether an entity can be a market participant associated with the open credit exchange platform 118, in accordance with defined registration and/or credit-exchange participation criterion(s).

In some implementations, the credit management component 120 can request and/or require that an entity (e.g., a prospective financial service provider) register with the open credit exchange platform 118 before allowing the entity to offer financial offer or other products via the open credit exchange platform 118. For example, when an entity desires to access the open credit exchange platform 118 as a financial service provider, the credit management component 120 can request information from the entity that can facilitate enabling the credit management component 120 to determine whether the entity can satisfy the set of defined conditions or rules to qualify as a financial service provider that can present financial offers or products via the open credit exchange platform 118. The requested information can include, for example, the amount of capital the entity possesses, the amount of liquid assets the entity possesses, the amount of time the entity has been engaged in the business of offering financial products or services, information that can indicate a reputation (e.g., business reputation) of the entity, and/or other information that can be used to facilitate determining whether the entity is qualified to be a financial service provider that can access the open credit exchange platform 118 in that capacity, in accordance with defined registration criterion(s).

The credit management component 120 can receive the requested information via a communication device (e.g., 106) of the entity (e.g., financial service provider 112), and can analyze the requested information. The credit management component 120 can determine whether the entity qualifies to be a registered entity authorized to issue financial offers or other products via the open credit exchange platform 118 based at least in part on the results of the analysis of the requested information and the set of defined conditions or rules, in accordance with defined registration criterion(s). The credit management component 120 can grant a set of access rights to an entity that it determines is qualified to be a registered entity or can deny access rights to an entity that it determines is not qualified to be a registered entity in relation to the open credit exchange platform 118.

In some implementations, the credit management component 120 can grant limited (e.g., probationary) access rights to newly registered entities, based at least in part on the results of the analysis of the requested information and the set of defined conditions or rules, in accordance with defined registration criterion(s). For example, the credit management component 120 can allow a newly registered entity with limited access rights the ability to issue certain financial offers (e.g., smaller financial offers, certain types of financial offers, or otherwise more restricted financial offers) that can be more restricted than financial offers permitted to be issued by other entities (e.g., financial service providers) that have additional (e.g., regular or ordinary) access rights to issue financial offers or products via the open credit exchange platform 118, while not allowing the newly registered entity to issue the types of financial offers that are permitted to be issued by the other entities having the additional access rights.

The credit management component 120 also can restrict, remove, or discontinue access rights of a registered entity, for example, in response to one or more abuse reports received from users (e.g., consumers, other financial service providers, etc.) received via the open credit exchange platform 118 or in response to other received information that indicate that the registered entity is no longer qualified to have its current access rights or is no longer qualified to be a registered entity, in accordance with defined registration criterion(s). For example, the credit management component 120 can place an entity on probation, and can restrict or remove some of the entity's access rights to the open credit exchange platform 118, in response to an abuse report(s) or in response to other received information that can indicate abuse by the entity. The probationary period for such restrictions or removal of access rights to the open credit exchange platform 118 can continue for a defined period of time or at least until the alleged abuse by the entity has been investigated by the credit management component 120 or an authorized agent associated with the credit management component 120 to determine whether the entity has engaged in abusive behavior that warrants further restriction or removal of access rights or a discontinuation of access rights for the entity with regard to the open credit exchange platform 118. As another example, the credit management component 120 can discontinue the access rights to the open credit exchange platform 118 of an entity or de-register the entity from the open credit exchange platform 118 in response to the credit management component 120 determining that the entity is no longer qualified to be a registered entity, based at least in part on the abuse report(s) or other received information that indicates abuse by the entity, in accordance with the defined registration criterion(s). The credit management component 120 can enforce the defined conditions or rules to prevent a de-registered entity from accessing the open credit exchange platform 118 with regard to financial offers, financial transactions, and/or communications with other entities associated with the open credit exchange platform 118 via the open credit exchange platform 118, etc.

In some implementations, to facilitate enabling financial service providers to make informed decisions regarding the issuing of approved financial offers, the credit management component 120 can monitor and collect (e.g., automatically or dynamically collect, manually collect or receive, etc.) personal information, financial information, and/or consumer behavior information respectively associated with users 104 (e.g., consumers), and/or other relevant information. The personal information, financial information, and/or consumer behavior information can include, for example, credit history of users (e.g., as reported by financial service providers (e.g., 112, 114, 116) associated with the open credit exchange platform 118, as reported by third-party credit reporting services (e.g., financial information provider 124), etc.), personal information (e.g., name, address, marital status, number of children, etc.) of users (e.g., 104), employment history of users, consumer transaction history of user, assets and/or liabilities of users, social profile information associated with users (e.g., as provided to the open credit exchange platform by users, as obtained from a third-party social networking site, etc.), demographic information (e.g., age, sex, marital or family status, level of education, type of employment, professional affiliation or credentials (e.g., professional license(s) or registration(s)), geographic location, income bracket, cost of living in geographic region, political affiliation, etc.) associated with users, etc. The credit management component 120 can continue (e.g., continuously in real or near real time, periodically, dynamically, etc.) to monitor, collect, and/or update the personal information, financial information, consumer behavior information, and/or other relevant information to facilitate enabling the financial service providers (e.g., 112, 114, 116) to assess such information in real or near real time and generate approved financial offers to present to users (e.g., 104).

The credit management component 120 can analyze and/or classify the personal information, financial information, consumer behavior information, and/or other relevant information to facilitate providing analysis or classification results, based at least in part on such information, to the financial service providers (e.g., 112, 114, 116) associated with the open credit exchange platform 118 via the respective communication devices (e.g., 106, 108, 110). In some implementations, the credit management component 120 can provide raw data of the collected personal information, financial information, consumer behavior information, and/or other relevant information to financial service providers (e.g., 112, 114, 116) associated with the open credit exchange platform 118 via the respective communication devices (e.g., 106, 108, 110). The credit management component 120 also can standardize data relating to the collected personal information, financial information, consumer behavior information, and/or other relevant information to facilitate presenting such information to the financial service providers (e.g., 112, 114, 116) via the respective communication devices (e.g., 106, 108, 110). For example, the credit management component 120 can process the collected personal information, financial information, consumer behavior information, and/or other relevant information to standardize or normalize such information to correspond to a defined number (N) of financial-related parameters associated with consumers to facilitate evaluation of the financial-related information by the financial service providers (e.g., 112, 114, 116), wherein N can be virtually any desired integer number. As part of the analysis or classification of such information, the credit management component 120 also can verify respective pieces of information, assign accuracy confidence levels to respective pieces of information (e.g., rate the accuracy of a piece of information on a scale ranging from 0% to 100%), or otherwise provide an indication of the strength of the accuracy of respective pieces of data to facilitate enabling the financial service providers (e.g., 112, 114, 116) to understand the accuracy and reliability of the respective pieces of information and analyze or assess the respective pieces of information accordingly.

The credit management component 120 also can analyze the financial-related information (e.g., personal information, financial information, consumer behavior information, and/or other relevant information) associated with the respective consumers, and can determine respective financial health scores of respective consumers (e.g., including user 104) based at least in part on the analysis of the financial-related information and defined financial assessment criteria. The credit management component 120 can make the respective financial health scores, and/or other information (e.g., the defined N financial-related parameters, confidence levels or scores for respective parameters or information, etc.), available (e.g., allow access of the financial health scores or present the financial health scores of consumers) to financial service providers (e.g., 112, 114, 116) associated with the open credit exchange platform 118 to facilitate enabling financial service providers to assess the financial risk of making approved financial offers to respective consumers (e.g., user 104) in accordance with the respective defined financial assessment criteria of the respective financial service providers. The credit management component 120 also can provide the financial health score to a communication device 102 or destination address (e.g., mobile phone number, email address, address associated with a social networking site or social networking message box, address associated with a digital wallet, etc.) associated with the consumer (e.g., user 104) to notify the consumer of the consumer's financial health score and/or as part of providing instruction to the consumer as to how the consumer can improve the consumer's financial health score, as more fully described herein. The credit management component 120 also can use the financial health scores of consumers to facilitate generating a mapping (e.g., real-time mapping) of approved financial offers from the financial service providers (e.g., 112, 114, 116) to the consumers (e.g., user 104), as more fully described herein.

As part of the always-on, always-updating features and mechanisms of the open credit exchange platform, the credit management component 120 can continue to monitor (e.g., automatically or dynamically monitor (e.g., dynamically monitor in response to a detected financial event), monitor in real or near real time) information relating to consumers, such as user 104. The credit management component 120 can update or modify (e.g., automatically, dynamically, or in real or near real time) the respective financial health scores of respective consumers based at least in part on evaluation of the monitored information and previous information (e.g., financial-related information) relating to the consumers, can store the updated or modified financial health scores of the respective consumers in respective user profiles of the consumers, and/or can make the updated or modified financial health scores of the respective consumers available to communication devices (e.g., 106, 108, 110) associated with the financial service providers (e.g., 112, 114, 116) and/or respective communication devices (e.g., 102) associated with the respective consumers (e.g., user 104).

With further regard to the financial service providers (e.g., 112, 114, 116), the communication devices (e.g., 106, 108, 110) of the financial service providers (e.g., 112, 114, 116) associated with (e.g., registered with, approved by, utilizing, etc.) the open credit exchange platform 118 can access or receive information (e.g., financial-related information, such as personal information, financial information, consumer behavior information, financial health scores, and/or other relevant information (e.g., demographic information); standardized or normalized information (e.g., the defined N financial-related parameters) based at least in part on the personal information, financial information, consumer behavior information, financial health scores, and/or other relevant information; other financial-related information (e.g., confidence levels or scores associated with respective items or information or parameters); etc.) from the credit management component 120 of the open credit exchange platform 118. The communication devices (e.g., 106, 108, 110) of the financial service providers (e.g., 112, 114, 116) can include or be associated with financial-service-provider (FSP) credit management components, such as FSP credit management component 126, FSP credit management component 128, and FSP credit management component 130. The FSP credit management components (e.g., 126, 128, 130) can respectively analyze (e.g., in real or near real time) the information received from the credit management component 120 of the open credit exchange platform 118 to facilitate respectively determining or identifying financial offers (e.g., approved credit offers) that the respective financial service providers (e.g., 112, 114, 116) desire to make to respective consumers (e.g., user 104) associated with the received information, in accordance with respective defined financial assessment criteria (e.g., defined financial offer or risk criteria) associated with the financial service providers (e.g., 112, 114, 116).

An FSP credit management component (e.g., 126, 128, 130) of a financial service provider (e.g., 112, 114, 116) can determine and generate approved (e.g., pre-approved, unconditionally approved) financial offers directed to respective users (e.g., user 104), based at least in part on the analysis of received information (e.g., personal information, financial information, consumer behavior information, and/or other relevant information; standardized or normalized information based at least in part on the personal information, financial information, consumer behavior information, and/or other relevant information; other financial-related information; etc.), and the defined financial assessment criteria associated with the particular financial service provider (e.g., 112, 114, 116). In some implementations, an FSP credit management component (e.g., 126, 128, 130) can structure the approved financial offers in a standardized form, in accordance with defined financial offer criteria (e.g., as specified by the credit management component 120 of the open credit exchange platform 118), to facilitate providing standardized approved financial offers to consumers (e.g., user 104) for an easy comparison by users and/or by the open credit exchange platform 118 (e.g., essentially an “apples-to-apples” comparison rather than an “apples-to-oranges” comparison). The FSP credit management components (e.g., 126, 128, 130) of respective financial service providers (e.g., 112, 114, 116) can provide or issue approved financial offers directed to respective users (e.g., user 104) to or via the open credit exchange platform 118 for further processing.

For each user, the credit management component 120 can receive or identify a set of approved financial offers directed to the user from one or more FSP credit management components (e.g., 126, 128, 130) of one or more respective financial service providers (e.g., 112, 114, 116) associated with the open credit exchange platform 118. The credit management component 120 can analyze or evaluate the approved financial offers in the set of approved financial offers to facilitate identifying or determining desirable approved financial offers, in accordance with the defined financial offer criteria. The credit management component 120 can identify or determine one or more desirable (e.g., the best or most preferred, or a subset of best or most preferred) approved financial offers from the set of approved financial offers directed to the user for presentation to the communication device 102 of the user 104.

For example, the credit management component 120 can determine or calculate a respective financial offer value (e.g., financial offer rating, financial offer score, etc.) for each approved financial offer in the set of approved financial offers based at least in part on the evaluation of the approved financial offers and in accordance with the defined financial offer criteria (and/or corresponding financial offer rules). The credit management component 120 can rank or order the approved financial offers in relation to each other based at least in part on their respective financial offer values (e.g., rank the approved financial offers from highest value to lowest value (or lowest value to highest value)). The credit management component 120 can identify the approved financial offer having the highest financial offer value as being the most desirable (e.g., best, most preferred, optimal, etc.) approved financial offer of the set of approved financial offers, and, as desired (e.g., when in accordance with the defined financial offer criteria), can identify an approved financial offer having the second highest financial offer value as being the second most desirable (e.g., second best or highest) approved financial offer of the set of approved financial offers, and so on. In some implementations (e.g., when in accordance with the defined financial offer criteria), the credit management component 120 can identify the preferred approved financial offer and/or one or more other approved financial offers in the set that meet or exceed a defined threshold (e.g., minimum threshold) financial offer value for selection and presentation to the consumer (e.g., user 104), and/or can select the preferred approved financial offer and/or one or more other approved financial offers in the set that meet or exceed the defined threshold financial offer value. The one or more desirable approved financial offers can be the preferred approved financial offer and/or the one or more other approved financial offers in the set that meet or exceed the defined threshold financial offer value.

The credit management component 120 can transmit the one or more desirable (e.g., most preferred or subset of most preferred) approved financial offers to the communication device 102 of the user 104, for example, via a push notification operation (e.g., the credit management component 120 can automatically, dynamically, or periodically push the approved financial offers to the communication device 102 of the user 104) or a pull notification operation (e.g., the communication device 102 can automatically, dynamically, periodically, or in response to a request for the approved financial offers from the user 104 of the communication device 102, request the approved financial offers from the credit management component 120). The notification of an approved financial offer can be in the form of, for example, a notification message associated with the financial application, a text message, an email message, or a voice mail message. A text message can be, for example, a short message service (SMS) message, an instant message (IM), a multimedia message (e.g., a multimedia messaging service (MMS) message), etc.

The communication device 102 (e.g., computer, mobile phone, electronic tablet, etc.) of the user 104 can receive the one or more desirable (e.g., the best or most preferred, or a subset of best or most preferred) approved financial offers, and/or notifications of such approved financial offers, from the credit management component 120. In some implementations, the communication device 102 can include (as depicted) or can access (e.g., via a web site) a consumer finances management component 132 that can be employed by the user 104 (e.g., consumer) to facilitate managing the finances of the user 104, accessing and/or using a digital wallet of the user 104, reviewing and/or accepting approved financial offers, executing financial transactions (e.g., making online or electronic payments for debts, goods, or services; accepting an approved financial offer and/or executing a contract; etc.), identifying a financial health or strength of the user 104, etc., as more fully described herein.

With regard to the one or more received approved financial offers, and/or notifications of such approved financial offers, the consumer finances management component 132 can process and present the one or more received approved financial offers and/or notifications of such approved financial offers to the user 104 via an interface(s) of the communication device 102. If the received information is a notification of an approved financial offer(s), the user 104 can use the consumer finances management component 132 to generate a message that can be sent to the open credit exchange platform 118 to facilitate obtaining further information regarding the approved financial offer(s) from the open credit exchange platform 118.

When the communication device 102 has the information relating to an approved financial offer(s), the user 104 can review the approved financial offer(s) on the communication device 102. If the user 104 decides to accept an approved financial offer, the user 104 can use the user's communication device 102 to access a contract associated with the approved financial offer, and can enter the user's electronic signature on the contract relating to the approved financial offer. For example, the user 104 can select a control (e.g., button, icon, etc.) on a user interface on the communication device 102 to accept the approved financial offer, and the communication device 102 can present the contract to the user 104 for signature (e.g., electronic signature) via the user interface (e.g., the contract can be provided with the approved financial offer when the offer is initially sent or can be provided to the communication device 102 by the credit management component 120 for presentation to the user 104 in response to the user 104 accepting the approved financial offer). The consumer finances management component 132 can employ a defined security protocol(s) (e.g., authentication and/or cryptographic protocols) to facilitate secure execution (e.g., electronic signing) of the contract by the user 104, as more fully disclosed herein.

The consumer finances management component 132 can facilitate transmitting (e.g., via a secure communication channel) the signed (e.g., executed) contract to the open credit exchange platform 118. The credit management component 120 of the open credit exchange platform 118 can evaluate the signed contract and can verify the signature (e.g., electronic signature) of the user 104 to facilitate validating and creating a legally binding contract relating to the approved financial offer. In accordance with various implementations, the credit management component 120 can electronically sign (e.g., automatically) the contract on behalf of the financial service provider that made the approved financial offer, can provide the contract to the financial service provider for signature (e.g., automatic signature) by the financial service provider, or the approved financial offer can be executed by the financial service provider prior to presenting the approved financial offer to the open credit exchange platform 118 for presentation to the communication device 102 of the user 104.

In response to validating the legally binding contract relating to the approved financial offer, the credit management component 120 can apply or deposit (e.g., automatically or instantaneously applied or deposited) the monetary funds or credit associated with the approved financial offer (and contract) to a financial account or financial transaction associated with the user 104. In some implementations, the user 104 can be registered with the open credit exchange platform 118 and can have a financial account in which funds can be deposited or credit can be applied and/or, at the time of accepting the approved financial offer or signing the contract, the user 104 can use the communication device 102 to enter information identifying a financial account to which the user 104 desires the funds or credit to be deposited or applied. In other implementations, it is not necessary for the user 104 to be registered with the open credit exchange platform 118, and, at the time of accepting the approved financial offer or signing the contract, the user 104 can use the communication device 102 to enter information identifying a financial account to which the user 104 desires the funds or credit to be deposited or applied.

As a result, the user 104 can be provided the financial benefit (e.g., monetary funds or credit, and associated financial conditions) associated with the approved financial offer (e.g., in relation to the purchase of a product or service), and the financial service provider (e.g., 112) can be provided the financial benefit (e.g., interest and fees relating to the extension of credit) as provided in the legally binding contract. Further, it is not necessary for the user 104 to prepare and submit a credit or loan application for consideration and approval by a financial service provider (e.g., 112), since the financial offer presented to the user has already been approved by the financial service provider (e.g., 112) based at least in part on the information previously made available to the financial service provider (e.g., 112) by the open credit exchange platform 118 and the defined financial assessment criteria of the financial service provider (e.g., 112).

In accordance with various aspects, the credit management component 120 of the open credit exchange platform 118 can facilitate securing data, and protecting the privacy of users associated with the open credit exchange platform 118. In some implementations, the credit management component 120 can expose information relating to consumers in an anonymous manner to FSP credit management components (e.g., 126, 128, 130) of the respective financial service providers (e.g., 112, 114, 116) associated with the open credit exchange platform 118, so that the financial service providers (e.g., 112, 114, 116) are not able to identify a consumer (e.g., user 104) by the consumer's actual identity, but are able to view financial-related information associated with the consumer, wherein the financial-related information associated with the consumer can be associated with a unique pseudo name or number. For example, the credit management component 120 can associate (e.g., link, map, etc.) financial-related information with a consumer identification (ID) number or name (e.g., a pseudo number or name) to facilitate obscuring the consumer's actual name from the FSP credit management components (e.g., 126, 128, 130) and respectively associated financial service providers (e.g., 112, 114, 116), wherein the credit management component 120 can make the consumer ID number of name available to the FSP credit management components (e.g., 126, 128, 130) with the associated financial-related information of the consumer without allowing the FSP credit management components (e.g., 126, 128, 130) to obtain or identify the actual name of the consumer. In certain implementations, the credit management component 120 can enable a consumer (e.g., user 104), using the consumer's communication device 102, to control the information (e.g., control the type or amount of information) of the consumer that is exposed to (e.g., made available to) the FSP credit management components (e.g., 126, 128, 130) and respectively associated financial service providers (e.g., 112, 114, 116). The credit management component 120 and/or the consumer's communication device 102 (e.g., via the financial application used by the communication device 102) can provide for transparency of the data by enabling the consumer to perceive and know which information of the consumer is being exposed to the FSP credit management components (e.g., 126, 128, 130) and respectively associated financial service providers (e.g., 112, 114, 116). The credit management component 120 and the consumer's communication device 102 (e.g., via the financial application) can employ an authentication protocol(s) or algorithm(s) to further facilitate securing data and financial transactions associated with the consumer in relation to the open credit exchange platform 118.

With further regard to the consumer finances management component 132 of the communication device 102, the consumer finances management component 132 can be provided to or accessed by the communication device 102 using an application (e.g., financial application). For example, the communication device 102 can download the application and install the application on the communication device 102 to facilitate installing the consumer finances management component 132 on the communication device 102. Additionally and/or alternatively, the application can be a web-based application, wherein the communication device 102 can access the application and the consumer finances management component 132 via a web browser of the communication component 102.

The consumer finances management component 132 can facilitate providing (e.g., presenting), for example, a digital wallet that can enable the user 104 to view all or a desired portion of the financial accounts (e.g., bank account(s), credit or loan account(s), etc.), available approved financial offers, bills (e.g., billing statement for a payment due on a credit account), financial transaction history, financial health or strength, and/or other information (e.g., user preferences) associated with the user 104. The digital wallet can provide (e.g., present, display, etc.) the current purchasing power (e.g., including available purchasing power via an approved financial offer(s)) of the user 104 to the user 104, wherein, the current purchasing power can include current assets (e.g., liquid assets, such as money in a bank account), open lines of credit, available lines of credit through approved financial offers, etc. The consumer finances management component 132 (e.g., through use of the digital wallet) can facilitate enabling the user 104 to view and/or accept an approved financial offer, execute a contract (e.g., electronically sign an electronic contract document relating to an approved financial offer), make a payment on a financial transaction, bill, or account, transfer monetary funds between accounts of the user 104, registering or providing information relating to accounts of the user 104, create a user profile, select or modify user preferences, and/or perform other functions or transactions.

The consumer finances management component 132 also can facilitate setting preferences of the user 104 with regard to data security (e.g., security of information relating to the user 104 and/or secure control of data of the user 104 that is exposed) by the open credit exchange platform 118 and/or communication device 102, selection of approved financial offers by the open credit exchange platform 118, conditions under which the open credit exchange platform 118 is to refinance (e.g., automatically) an account(s) of the user 104 or notify the user 104 of an opportunity to refinance an account(s), notification of the user 104 in relation to financial health (e.g., in relation to a change in financial health or strength, in relation to instruction to facilitate improving financial health or strength), and/or other functions associated with the consumer finances management component 132 or credit management component 120. The consumer finances management component 132 can store the user preferences in a user profile of the user 104, which can be stored in a data store, and can provide (e.g., transmit) the user profile and/or user preferences to the open credit exchange platform 118, wherein the credit management component 120 can store the user preferences (e.g., in the user profile generate by the communication device 102 or in a user profile generated by the credit management component 120). The credit management component 120 can implement the user preferences to facilitate identifying or selecting approved financial offers for the user 104, securing data associated with the user 104, identifying a financial health of the user 104, sending notifications to the user 104, etc.

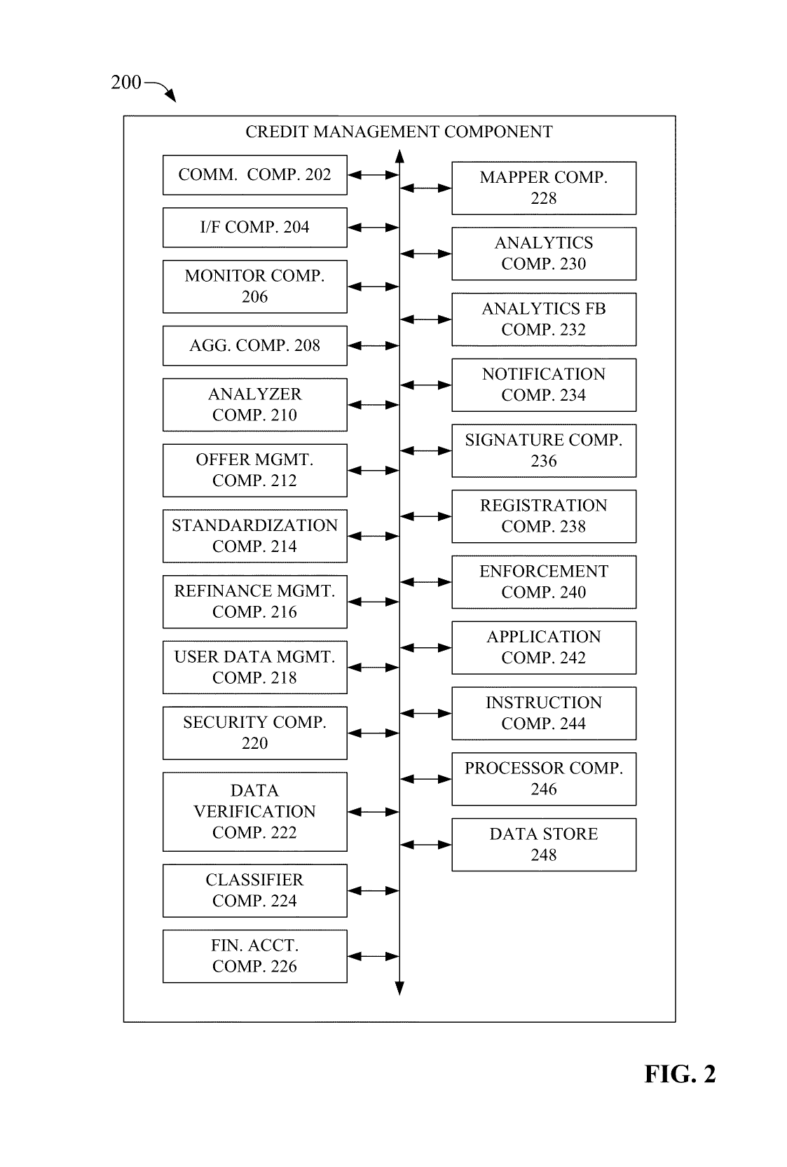

FIG. 2 depicts a block diagram of an example credit management component 200, in accordance with various aspects and embodiments of the disclosed subject matter. The credit management component 200 can be part of or associated with an open credit exchange platform, for example.

The credit management component 200 can comprise a communication component 202 (COMM. COMP. 202) that can communicate (e.g., transmit, receive) information, including financial-related information associated with users (e.g., consumers), information relating to approved financial offers, and/or other information, between the credit management component 200 and other components or devices, such as communication devices associated with users, financial service providers, and/or financial information providers. The communication component 202 can employ one or more communication protocols to facilitate controlling data or voice flows, and/or wireless or wireline communication of traffic (e.g., voice or data traffic), associated with the credit management component 200.

The credit management component 200 can include an interface component 204 (I/F COMP. 204) that can comprise one or more interfaces, including one or more controls, switches, adapters, connectors, buttons, routers, speakers, display screens, graphical user interfaces (GUIs), and/or touch screen GUIs, etc., that can facilitate enabling the credit management component 200 to interface and/or communicate with other systems, components, or devices (e.g., communication devices associated with consumers, financial service providers, or financial information providers; systems, components, or devices associated with a communication network(s); etc.), or users (e.g., administrators, engineers, technicians, etc.) associated with the open credit exchange platform. The interface component 204 can facilitate establishing a communication channel (e.g., a secure wireless or wireline communication channel) between the credit management component 200 and a communication device (e.g., of a consumer, financial service provider, financial information provider, etc.) associated with the open credit management platform.

The credit management component 200 can comprise a monitor component 206 (MONITOR COMP. 206) that can monitor (e.g., continuously, periodically, dynamically (e.g., in response to a condition for monitoring information being met), etc.) information in real or near real time. The monitor component 206 can monitor, for example, financial-related information associated with respective consumers (e.g., as directly obtained by the credit management component 200, as obtained from financial service providers, as obtained from financial information providers, as provided by consumers, etc.), approved financial offers being provided by communication devices associated with financial service providers, outstanding debts associated with respective consumers, user preferences, etc.

The credit management component 200 also can contain an aggregator component 208 (AGG. COMP. 208) that can aggregate or collect the information (e.g., financial-related information, approved financial offers, user preferences, etc.). For instance, the aggregator component 208 can aggregate information received (e.g., obtained) from various entities (e.g., monitor component 206 or another component(s) of the credit management component 200, communication network, an application (e.g., a financial application, which can be a mobile or web application), a server or other communication device, processor, data store, etc.). For example, the aggregator component 208 can facilitate collecting and aggregating various approved financial offers from various financial service providers associated with the open credit exchange platform to facilitate determining respective preferred approved financial offers for respective consumers or respective groups of consumers (e.g., respective credit of financial groups). The aggregator component 208 can correlate respective items of data based at least in part on type of data (e.g., information relating to a particular financial transaction, information relating to a particular financial offer, type of offer, type of consumer or group of consumers to which an offer is directed, metadata, etc.), a consumer to which the data relates, source of the data, time or date the data was generated or received, etc., to facilitate analyzing or evaluating of the data by the analyzer component 210 (ANALYZER COMP. 210) or another component of the credit management component 200.

The analyzer component 210 can analyze, evaluate, and/or parse information (e.g., financial-related information, approved financial offers, user preferences, etc.) to facilitate identifying one or more desirable (e.g., a best or most preferred, or a subset of best or most preferred) approved financial offers, identifying or standardizing respective financial-related parameters or factors (e.g., N financial-related parameters or factors), synthesizing various pieces of information (e.g., financial-related information or other information associated with a consumer) to generate a financial-related parameter(s) or factor(s), adjusting a user profile relating to a user (e.g., consumer, financial service provider, etc.), verifying an electronic signature of a consumer, determining whether to refinance a loan or consolidate a plurality of loans and/or credit account balances, etc. The analyzer component 210 can generate analysis results based at least in part on the analyzing, evaluating, and/or parsing of such information, and can provide the analysis results to another component(s) (e.g., offer management component 212, refinance management component 216, classifier component 224, etc.) for further processing.

The credit management component 200 can comprise an offer management component 212 (OFFER MGMT. COMP. 212) that can evaluate approved financial offers directed to a consumer and received from respective financial service providers. Based at least in part on the results of the evaluation, the offer management component 212 can identify and select (e.g., automatically or dynamically identify and select) one or more desirable (e.g., a best or most preferred, or a subset of best or most preferred) approved financial offers, in accordance with the defined financial offer criteria. The credit management component 200, using the communication component 202 and/or another component(s) (e.g., notification component 234), can facilitate communicating the one or more desirable approved financial offers to a communication device associated with the consumer.

The credit management component 200 also can include a standardization component 214 (STANDARDIZATION COMP. 214) that can facilitate standardizing approved financial offers (e.g., pre-approved or unconditionally approved financial offers) and/or other financial products of different financial service providers to facilitate comparing approved financial offers and/or other financial products of different financial service providers and identifying a preferred approved financial offer and/or product. The standardization component 214 can standardize respective types of financial offer parameters (e.g., amount of loan or line of credit, interest rate for loan or line of credit, loan repayment period, down payment terms, prepayment terms, etc.) for respective types of financial offers (e.g., mortgage loans, automobile loans, other types of loans, lines of credit, etc.) As more fully disclosed herein (e.g., with regard to the credit management component, the standardization component 214 can present standardized financial offer or product parameters to communication devices of respective financial service providers to facilitate the generation of standardized approved financial services or other standardized financial products by the respective financial service providers via the open credit exchange platform, wherein the standardized approved financial services or products can be offered to consumers associated with the open credit exchange platform. For example, the standardization component 214 can present standardized financial offer parameters using one or more lists or menus (e.g., presented using the interface component 204), comprising the available standardized financial offer parameters, from which financial service providers can select desired financial offer parameters using their respective communication devices.

The credit management component 200 further can employ a refinance management component 216 (REFINANCE MGMT. COMP. 216) that can monitor and evaluate open loans, credit accounts, etc., associated with a consumer to facilitate determining whether to refinance (e.g., automatically refinance) a loan associated with the consumer, or refinance and consolidate a plurality of loans and/or credit account balances associated with the consumer to a new loan. Based at least in part on the results of the evaluation, the refinance management component 216 can determine (e.g., automatically or dynamically determine) whether to refinance a loan, or refinance and consolidate a plurality of loans and/or credit account balances to a new loan, in accordance with the defined financial offer criteria. For example, the refinance management component 216 can evaluate (e.g., automatically, dynamically, periodically, etc.) two loan balances having respective interest rates, and can evaluate approved loan offers (e.g., approved refinance loan offers) available to the consumer, to facilitate determining whether it is desirable (e.g., proper, beneficial, etc.) to refinance the two loans balances through a new approved loan based on an approved loan offer, in accordance with the defined financial offer criteria and/or user preferences of the potential offeree. If the refinance management component 216 determines that refinancing the two loan balances through a new approved loan meets the defined financial offer criteria and/or the user preferences, the refinance management component 216 can refinance (e.g., automatically or dynamically, or in response to a consumer's instruction to accept the approved financial offer) the two loan balances to generate a new approved loan associated with the user.

As another example, with regard to a particular consumer, the credit management component 200 can treat all or a portion of the debt (e.g., one or more debts) of the consumer as a debt instrument, which can have a face value in the form of the remaining balance owed and the perspective earnings that can be derived from the debt, and does not have a fixed rate of interest over the life of the debt instrument. In contrast to an adjustable rate loan, which typically can use an index or other base rate for establishing the interest rate for each relevant period, which potentially could increased to the disadvantage of the consumer (e.g., borrower), the credit management component 200 can manage the debt instrument such that changes of the terms of the debt instrument (e.g., associated with one or more debts of the consumer) only can occur when such changes of the terms favor the consumer (e.g., such changes of the terms are to the financial advantage of the consumer, wherein such changes result in, for example, a better interest rate, a reduced monthly payment, and/or a reduced (or increased) term for paying off the debt, etc.), in accordance with the defined financial offer criteria and/or user preferences of the consumer.

In addition to or as an alternative to refinancing a loan or debt instrument associated with a consumer, the refinance management component 216 can evaluate other factors, user preferences, criterion(s), etc., to facilitate determining whether to refinance (e.g., automatically refinance) the loan or debt instrument. For example the refinance management component 216 can determine whether to refinance loans or debts to consolidate them into one loan (e.g., having a potentially longer or shorter loan term depending in part on the interest rate differential between the loans terms and respective fees), to reduce the monthly payment (e.g., repayment) amount (e.g., over a longer repayment term, depending in part on the interest rate differential between the loans terms and respective fees), to reduce or alter risk of the consumer (e.g., switching the debt from a variable-rate loan to a fixed-rate loan), to enhance the monetary flow of the consumer (e.g., by refinancing the debt over a longer repayment term, depending in part on the interest rate differential between the loans terms and respective fees), etc.

As an example of debt refinancing, the refinance management component 216 can allow a change of interest rate (e.g., to a lower interest rate) through refinancing on behalf of the consumer for all or a portion of the debt of the consumer via the open credit exchange platform. The refinance management component 216 can allow the debt instrument (e.g., virtual debt instrument) associated with (e.g., representing) all or the portion of the debt to always be open for bidding by the financial service providers associated with the open credit exchange platform. The refinance management component 216 and/or monitor component 206 can monitor bids (e.g., approved financial offers) from financial service providers associated with the open credit exchange platform. The refinance management component 216 and/or the analyzer component 210 can analyze the bids, and, for each bid, can analyze the benefits of refinancing the debt instrument and the costs of refinancing the debt instrument, and evaluate (e.g., compare the benefits of refinancing the debt instrument in relation to the costs of refinancing the debt instrument, in accordance with the defined financial offer criteria and/or user preferences of the consumer. For the most preferred bid (e.g., preferred approved financial offer), if the refinance management component 216 determines that the benefits of refinancing the debt instrument outweigh the costs of refinancing the debt instrument, the refinance management component 216 can automatically refinance the debt instrument of the consumer (e.g., based on the consumer's prior contractual agreement to permit such automatic refinancing and/or to allow the open credit exchange platform to act as a legal representative (e.g., via an executed power of attorney or an executed legal proxy document) of the consumer that is authorized by the consumer to enter the consumer into a legally binding contract associated with refinancing the debt instrument in accordance with the preferred approved financial offer), or can send a notification to the communication device of the consumer to facilitate notifying the consumer of most preferred bid, recommending that the consumer accept the most preferred bid, providing reasons (e.g., net benefits) for recommending the consumer accept the most preferred bid, etc. As part of the automatic refinancing process, the refinance management component 216, through competition for the consumer's debt instrument, as already agreed to by the consumer (e.g., in accordance with the user preferences and/or contractual agreement associated with the consumer), wherein the competition can be “behind the scenes” (e.g., not directly involving the consumer or requiring the consumer to evaluate refinance bids and take action to accept a refinance bid) and can benefit the consumer without forcing the consumer through a new loan product or transaction costs.

The open exchange credit platform, comprising the refinance management component 216 and other disclosed components, can thereby assess paper value (e.g., the value of a debt instrument associated with a consumer), group that paper (e.g., debt instrument) with other debt instruments, based at least in part on a defined unified criterion(s) (e.g., defined financial offer criterion(s) relating to grouping of debt instruments), so that bidders (e.g., financial service providers) are not required to take the time to review and analyze the respective debt instruments to assess what they can or are willing to offer for such debt instruments. The refinance management component 216 (or another component(s) of the open credit exchange platform) can allow financial service providers (via their respective communication devices and/or FSP credit management components) to set or select a sell trigger for a group of debt instruments or a type of group of debt instruments, or a buy trigger for a group of debt instruments or a type of group of debt instruments. A sell trigger associated with an approved financial offer can specify a trigger price for selling a group of debt instruments, and a buy trigger associated with an approved financial offer can specify a trigger price for buying a group of debt instruments. For example, if a financial service provider creates an approved financial offer (e.g., a preferred approved financial offer) for a group of debt instruments with a buy trigger set at x dollars, the refinance management component 216 can facilitate executing the transaction when the buy trigger price of x dollars is satisfied (e.g., occurs), and the financial service provider will have purchased the group of debt instruments for x dollars.

The financial accounts of the financial service providers, and the consumers associated with the debt instruments in the group of debt instruments can be updated by the credit management component 200 accordingly. The credit management component 200 can facilitate the transfer (e.g., automatic transfer) of ownership from one entity or set of entities (e.g., financial service provider(s) associated with the debt instrument(s)) to the purchasing entity (e.g., the financial service provider who purchased the debt instrument). In some implementations, the credit management component 200 (e.g., including the refinance management component 216) can manage refinancing of debt instruments or other purchases via approved financial offers based on other financial terms or defined financial offer criterion in addition to or as an alternative to buy or sell triggers (e.g., a trigger(s) based on credit rating of consumer(s), loan amount associated with a debt instrument, etc.).

The refinance management component 216 and/or other components of the credit management component 200 can facilitate performing refinance transactions so that they are transparent to the consumer, partially transparent to the consumer, or not transparent to the consumer, based at least in part user preferences of the consumer. For example, if the user preferences of the consumer permit that the refinance transactions of the consumer's debt can be transparent, the credit management component 200 is not required to notify the consumer regarding who is a current entity (e.g., financial service provider) that owns the debt instrument of the consumer as a result of a refinancing of the debt instrument through that current entity.

The credit management component 200 also can contain a user data management component 218 (USER DATA MGMT. COMP. 218) that can collect, manage, and secure data associated with users (e.g., consumers, financial service providers, financial information providers, etc.) who are associated with (e.g., registered with, affiliated with, using, etc.) the open credit exchange platform. The user data management component 218 can make available financial-related information or other information to entities, such as the financial service providers, associated with the open credit exchange platform to facilitate enabling the financial service providers to accurately evaluate (e.g., estimate or score) the financial risk of making an approved financial offer to a consumer.

In some implementations, the user data management component 218 can control what information associated with consumers is exposed to financial service providers, for example, based at least in part on defined security criteria and/or user preferences of the consumer. The user data management component 218 can provide a desired level of anonymity to users (e.g., consumers) to hide or obscure a user's actual name or other user information from other entities (e.g., financial service providers) associated with the open credit exchange platform. For example, the user data management component 218 can generate (e.g., randomly generate) a pseudo ID name or number for a consumer that can be provided to other entities associated with the open credit exchange platform, instead of providing the consumer's actual name as an ID to the other entities.

The credit management component 200 also can include a security component 220 (SECURITY COMP. 220) that can secure data associated with the open credit exchange platform and also can operate in conjunction with the user data management component 218 to facilitate securing such data. The security component 220 can operate in conjunction with the communication component 202 to establish a secure communication channel between the open credit exchange platform and communication devices associated with users (e.g., consumers, financial service providers, financial information providers, etc.), in accordance with a defined security protocol(s) and defined security criteria. For example, the security component 220 can establish a secure communication channel in accordance with a secure sockets layer (SSL) protocol and/or other cryptographic protocol. The security component 220 can encrypt data that is to be transmitted to a communication device, and can decrypt encrypted data received from a communication device, in accordance with an appropriate cryptographic protocol (e.g., a protocol relating to data encryption and decryption, public key cryptography, symmetric key, Public key infrastructure (PKI), Digital Signature Standard (DSS), Data Encryption Standard (DES), triple-DES, Advanced Encryption Standard (AES), cryptographic hash functions, etc.).

The security component 220 also can utilize authentication procedures to authenticate communication devices and associated users attempting to access the open credit exchange platform. For example, the security component 220 can control access to the open credit exchange platform based at least in part on verification of authentication credentials provided by communication devices of users. The security component 220 can grant certain access rights to a communication device of a user in response to verifying the authentication credentials presented by the communication device, wherein the access rights granted can be based at least in part on the particular user (e.g., type of user, such as consumer, financial service provider, financial information provider, etc.), the authentication credentials presented, and/or defined security criteria. For example, in accordance with the defined security criteria, the security component 220 can grant a consumer (and associated communication device) registered with the open credit exchange platform a first subset of access rights to the open credit exchange platform, and grant a financial service provider (and associated communication device) registered with the open credit exchange platform a second subset of access rights to the open credit exchange platform. Authentication credentials can include or be based at least in part on, for example, a username, a password, a personal identification number (PIN), biometric information (e.g., fingerprint information, eye or iris related information, facial recognition related information, etc.) associated with a user, a communication device identifier (e.g., Media Access Control (MAC) address) associated with a communication device, etc.

The security component 220 also can operate in conjunction with the user data management component 218 to facilitate generating (e.g., randomly generating) a pseudo ID name or number for a consumer that can be provided to other entities associated with the open credit exchange platform, instead of providing the consumer's actual name as an ID to the other entities. In some implementations, the security component 220 can use a random number generator component that can generate random or pseudo-random numbers that can be used to facilitate generating a pseudo ID name or number for a consumer.

The credit management component 200 can further include a data verification component 222 (DATA VERIFICATION COMP. 222) that can verify and/or identify confidence levels (e.g., accuracy, authenticity, trust, etc., levels) of respective pieces of data. In some implementations, the data verification component 222 can operate in conjunction with or can be part of the user data management component 218 to facilitate identifying the reliability of the data (e.g., accuracy, authenticity, trustworthiness, etc., of the data) collected and managed by the user data management component.

The data verification component 222 can evaluate a piece of data, metadata associated with the piece of data, the type of data the piece of data is, the source of the piece of data, the age of the piece of data, other data potentially relevant to the piece of data (e.g., other data that can or may corroborate the accuracy, authenticity, trustworthiness, etc., of the piece of data), and/or other factors, and can verify the piece of data or identify a confidence level to assign the piece of data based at least in part on the evaluation. For example, the data verification component 222 can identify a piece of data as having a high level of accuracy and trustworthiness based at least in part on identifying that the piece of data is from a reputable source and/or the accuracy and trustworthiness of the information in the piece of data is corroborated by other data. The data verification component 222 can identify another piece of data as having a relatively low level of accuracy or trustworthiness based at least in part on identifying that this other piece of data is from a non-reputable or biased source (e.g., a consumer's job income as stated by the consumer) and/or the accuracy and trustworthiness of the information in the piece of data is not corroborated by other data (e.g., the consumer's job income, as stated by the consumer, is not corroborated or supported by other data evidencing that the consumer's job income is as the consumer stated). The data verification component 222 can assign a confidence level ranging, for example, from 0% (e.g., unverified or completely inaccurate) to 100% (e.g., completely accurate and/or verified), from low(est) confidence level (e.g., unverified or completely inaccurate) to high(est) confidence level (e.g., completely accurate and/or verified), and/or other types of confidence levels (e.g., respective color coding of respective confidence levels, such as, for example, green color to indicate verified and/or accurate data, yellow color to indicate a lower confidence level in the accuracy or trustworthiness of the data, and red color to indicate the lowest confidence level in the accuracy or trustworthiness of the data and/or to indicate that the data has not yet been evaluated for verification).

The credit management component 200 also can comprise a classifier component 224 (CLASSIFIER COMP. 224) that can classify or standardize financial products (e.g., approved financial offers) to facilitate enabling a user to do an informed comparison of the respective financial products (e.g., do an “apples-to-apples” comparison, instead of an apple-to-oranges comparison. For example, the classifier component 224 can take a first approved financial offer having a first set of financial terms or conditions and a second approved financial offer having a second set of financial terms or conditions, and can synthesize the information associated with the first and second approved financial offers to present them to the user in a way so as to facilitate enabling the user to do an informed comparison of the respective approved financial offers. For instance, the classifier component 224 can identify pertinent factors (e.g., monthly payment, number of months for repayment, effective interest rate, total repayment amount, etc.) for each of the first and second approved financial offers, and can present this information to the communication device of the user for comparison.

The credit management component 200 can further contain a financial account component 226 (FIN. ACCT. COMP. 226) that can facilitate maintaining respective account information (e.g., financial account information, such as account number, outstanding balance, payment history, monthly payment amount, interest rate, etc.) of respective users (e.g., consumers, financial service providers, etc.), depositing funds to or withdrawing funds from a financial account of a user, transferring funds from one financial account to another financial account, adjusting a credit line or financial terms associated with a financial account, etc. For example, the financial account component 226 (e.g., operating in conjunction with the refinance management component 216 or other component) can facilitate generating a new financial account in relation to a refinance loan and can transfer outstanding balances of one or more financial accounts to the new financial account and/or close the one or more financial accounts after the transfer.

The financial account component 226 also can facilitate enabling a user to view and manage a digital wallet associated with the user's financial accounts recognized or maintained by the open credit exchange platform. For example, a user can use a communication device (e.g., via the financial application) to access, view, and/or manage the user's digital wallet and associated financial accounts, wherein the user can view a status (e.g., outstanding balance, payment status, etc.) or other information associated with a financial account, make payments on a financial account associated with the digital wallet, withdraw funds from or deposit funds to a financial account associated with the digital wallet, modify information associated with a financial account, etc.

The credit management component 200 also can comprise a mapper component 228 (MAPPER COMP. 228) that can generate a mapping (e.g., in real or near real time) of an item(s) of data to another item(s) of data to facilitate enabling approved financial offers to be identified and provided to consumers. For example, the mapper component 228 can generate a mapping of consumer parameters (e.g., credit history of a consumer, current income of a consumer, current outstanding debt of a consumer, current debt-to-income ratio of the consumer, consumer behavior, current potential financial transaction of a consumer, etc.) identified for respective consumers to a set of approved financial offers (e.g., in relation to financial transactions) from respective financial service providers to facilitate identifying one or more approved financial offers for presentation to a consumer via the consumer's communication device. In some implementations, the mapper component 228 can generate a mapping of approved financial offers (e.g., generic approved financial offers not expressly directed to a consumer by a financial service provider) to consumers, based at least in part on the consumer parameters. For example, a financial service provider can provide, via a communication device, an approved financial offer, which is not specifically directed to a consumer by the financial service provider, to the open credit exchange platform, wherein the approved financial offer can have a set of qualifications for a consumer to be pre-approved to accept the approved financial offer. The mapper component 228 and/or another component(s) (e.g., analyzer component 210) of the credit management component 200 can evaluate the set of qualifications associated with the approved financial offer and respective consumer parameters of consumers, can identify one or more consumers who qualify for the approved financial offer, and can generate a mapping between the approved financial offer and the one or more qualifying consumers. The credit management component 200 can utilize this mapping to facilitate determining whether to present a consumer with the approved financial offer and/or notifying a financial service provider of consumers who meet the set of qualifications, wherein the financial service provider can determine whether to extend the approved financial offer to the one or more of the qualifying consumers.

The credit management component 200 can include an analytics component 230 (ANALYTICS COMP. 230) that can generate respective analytics (e.g., performance analytics) that can provide detailed information regarding the respective performances of approved financial offers of respective financial service providers. The analytics component 230 can generate or determine analytics (e.g., performance analytics) that can identify the respective performances of the approved financial offers or other financial products of a financial service provider relative to same or similar offers of other financial service providers and/or relative to various credit or offer groups (e.g., various groups of consumers, wherein each group can be associated with respective financial characteristics (e.g., respective range of financial health scores, respective range of incomes, respective range of credit ratings, etc.), as more fully disclosed herein with regard to the credit management component.

The credit management component 200 also can contain an analytics feedback component 232 (ANALYTICS FB COMP. 232) that can generate analytics feedback information that can comprise all or a portion of the analytics and/or information relating to the analytics. The analytics feedback information can include, for example, information identifying the number of offers made by a financial service provider (e.g., over a defined time period), information identifying the number of offers selected as preferred by the credit management component 200 (e.g., over a defined time period), information identifying the number of offers accepted by a consumer(s) (e.g., over a defined time period), information identifying those terms of certain offers of the financial service provider that have determined to be causing or at least potentially be causing those certain offers to underperform, information identifying those terms of certain other offers that have been determined to be responsible or at least potentially be responsible for those certain other offers of the financial service provider performing relatively well, information identifying the one or more offer modifications (e.g., modification of terms of offers) that can be made to underperforming offers to facilitate improving those underperforming offers, and/or other desired information.

The credit management component 200 can comprise a notification component 234 (NOTIFICATION COMP. 234) that can generate notifications relating to approved financial offers to facilitate notifying consumers of the approved financial offers. For instance, the notification component 234 can generate a notification of an approved financial offer (e.g., a best or most preferred approved financial offer) for a consumer, and the credit management component 200 (e.g., using the communication component 202) can transmit this notification to a communication device associated with that consumer. The notification component 234 also can generate other types of notifications to facilitate providing information relating to a consumer's finances to the communication device associated with the consumer. For example, the notification component 234 can generate a notification relating to the financial health of a consumer (e.g., notification relating to the status of consumer's financial health, a change in the status of the consumer's financial health or strength, an automatic refinance of an account(s) or loan(s) of the consumer, etc.) or a notification relating to an action(s) a consumer can take to facilitate improving the consumer's financial health or strength.

The notification component 234 also can generate a notification relating to selection (e.g., by the credit management component 200) of an approved financial offer made by a financial service provider. For example, the notification component 234 can generate a notification that the credit management component 200 selected an approved financial offer made by a financial service provider or a notification that a consumer accepted the approved financial offer, and the credit management component 200 can transmit such notification(s) to a communication device associated with the financial service provider to notify the financial service provider that the approved financial offer was selected or accepted. The notification component 234 further can generate a notification relating to or comprising analytics feedback information that can be sent to a communication device of a financial service provider to facilitate notifying the financial service provider of the analytics feedback information or its availability, and the credit management component 200 can transmit such notification to the communication device of the financial service provider.

The credit management component 200 also can contain a signature component 236 (SIGNATURE COMP. 236) that can verify or authenticate an electronic signature of a user(s) (e.g., consumer, financial service provider, etc.) in relation to a contract (e.g., an electronic document that includes a contract) between a consumer and a financial service provider relating to an approved financial offer by the financial service provider to the consumer. The signature component 236 (e.g., operating in conjunction with the security component 220) can evaluate an electronic signature provided by a user and can determine whether the electronic signature provided by the user is valid or verified, in accordance with the defined security criteria. If the signature component 236 verifies an electronic signature of a consumer on a contract relating to an approved financial offer, for example, a legally binding contract can be created, and the financial benefits (e.g., monetary funds, credit line, etc.) associated with the approved financial offer can be provided (e.g., deposited) to a financial account of the consumer or applied to a financial transaction being made by the consumer.

The credit management component 200 can include a registration component 238 (REGISTRATION COMP. 238) that can register users (e.g., consumers, financial service providers, financial information providers, etc.), with the open credit exchange platform. The registration component 238 can receive information from a communication device of a user or can generate information to facilitate registering users and/or generating authentication credentials for users to use when attempting to access the open credit exchange platform. For example, the registration component 238 can receive a user's (e.g., consumer's) personal information (e.g., name, address, phone number, etc.), job history, financial information associated with the user (e.g., income history, bank or credit account information, loan information, etc.), to facilitate registering the user with the open credit exchange platform. The registration component 238 also can receive information relating to authentication credentials from the user to facilitate generating authentication credentials for the user and/or can generate authentication credentials that can be assigned to the user. The registration component 238 also can register other types of users, such as financial service providers, financial information providers, etc., with the open credit exchange platform, wherein the registration component 238 can receive or generate respective items of information associated with respective users to facilitate registering the respective users with the open credit exchange platform and/or generating or assigning respective authentication credentials to the respective users. For each of the respective users, the registration component 238 can generate a user profile and can store information associated with the user in the user profile of the user, wherein the registration component 238 can store user profiles in the data store 248.

The credit management component 200 further can comprise an enforcement component 240 (ENFORCEMENT COMP. 240) that can enforce defined conditions or rules for regulating the participation of financial service providers or other users (e.g., consumer, financial information provider, etc.) associated with the credit exchange. As more fully disclosed herein (e.g., with regard to the credit management component), the enforcement component 240 can facilitate enforcing defined conditions or rules (e.g., registration and/or credit-exchange participation conditions or rules) relating to registration of users with the credit exchange and/or participation of users in the credit exchange. The defined conditions or rules can relate to, for example, a minimum amount of capital (e.g., money or other assets) and/or a minimum amount of liquid assets that an entity is required to have to qualify to be permitted to be a market participant (e.g., financial service provider) associated with the credit exchange and open credit exchange platform, a minimum amount of time that an entity has been engaged in the business of offering financial products or services in order to qualify to be permitted to be a market participant associated with the credit exchange and open credit exchange platform, a defined reputation (e.g., reputation score or assessment) that can demonstrate the entity has a sufficiently good reputation to qualify to be permitted to be a market participant associated with the credit exchange and open credit exchange platform, and/or other specifications (e.g., requirements) for determining whether an entity can be a market participant associated with the credit exchange and open credit exchange platform, in accordance with defined registration and/or credit-exchange participation criterion(s).

The enforcement component 240 can apply or enforce differing levels of market participation with the open credit exchange platform based at least in part on the respective qualifications of respective financial service providers. For example, the enforcement component 240 can facilitate allowing a first financial service provider to register and make approved financial offers in the credit exchange in accordance with a first set of conditions, allowing a second financial service provider to register and make approved financial offers in the credit exchange in accordance with a second set of conditions, based at least in part on the respective qualifications of the first financial service provider and the second financial service provider. For instance, the first financial service provider can be a market participant that has a good reputation but a relatively lower amount of available capital, and as a result, the enforcement component 240 can determine that the first financial service provider is only authorized to make approved financial offers in the credit exchange at or below a first defined financial amount. The second financial service provider can be a market participant that has a good reputation and has relatively high amount of available capital, and as a result, the enforcement component 240 can determine that the second financial service provider can be authorized to make approved financial offers in the credit exchange at or below a second defined financial amount that is higher than the first defined financial amount. The enforcement component 240 can continue to monitor the qualifications of the respective financial service providers to facilitate managing their participation in the credit exchange, and can facilitate enforcing any modifications to the respective conditions for participation in the credit exchange by the respective financial service providers with regard to making approved financial offers for new financial products or refinancing offers. The credit management component 200 can thereby facilitate determining the amount of financial risk a financial service provider is able to take on, or at least the amount of financial risk, the credit management component 200 is willing to allow the financial service provider to take on via its participation with the credit exchange, and the enforcement component 240 can enforce the conditions of participation in the credit exchange by the financial service provider based at least in part on the amount of financial risk the credit management component 200 is willing to permit the financial service provider to take on via its participation with the credit exchange.

In some implementations, a market participant can be granted (e.g., via the registration component 238) a set of probationary access rights that can provide the market participant with a more limited amount of access to the credit exchange for a defined probationary time period (e.g., 30 days, 60 days, 90 days, or other desired amount of time). If the credit management component 200 determines that the market participant has satisfied the terms of the probationary grant of access, the credit management component 200 can grant the market participant with an ordinary set of access rights that is, in accordance with the market participant's qualifications to participate in the credit exchange, as determined by the credit management component 200. If the credit management component 200 determines that the market participant has not satisfied (e.g., not fully satisfied) the terms of the probationary grant of access to the credit exchange, the credit management component can extend the probationary period for access to the credit exchange under the current set of probationary access rights, modify the set of probationary access rights (e.g., to grant more or less access rights to the credit exchange to the market participant), or discontinue providing the market participant with access rights to the credit exchange at least as a financial service provider.

The credit management component 200 can contain an application component 242 (APPLICATION COMP. 242) that can generate, update, and/or use one or more applications to facilitate operation of the open credit exchange platform, access or use of the open credit exchange platform by communication devices of users. In some implementations, the application component 242 or another component of the credit management component 200 can provide respective applications (e.g., financial applications) to respective communication devices of respective users, wherein the communication devices can use the respective applications to facilitate accessing and using the open credit exchange platform. The application (e.g., consumer financial application) used for a communication device associated with one type of user (e.g., consumer) can be the same as or different from an application (e.g., FSP financial application) used for a communication device associated with another type of user (e.g., financial service provider, and/or an application used for one type of communication device (e.g., desktop computer) can be the same as or different from an application (e.g., mobile application) used for another type of communication device (e.g., mobile phone, electronic pad or tablet).

The credit management component 200 also can include an instruction component 244 (INSTRUCTION COMP. 244) that can evaluate information (e.g., financial information, such as, for example, credit history, consumer behavior, current income, current debt obligations, current financial strength or health, etc.) of the consumer to identify one or more recommended actions that the consumer can or may take to facilitate improving the consumer's financial strength or health. A recommended action can include information relating to the type(s) of action(s) or step(s) the consumer can take, a reason(s) why the recommended action can be beneficial to the consumer, an expected or estimated value of the benefit that can be obtained by the recommended action, or other information. The instruction component 244 (e.g., via the communication component 202) can provide the one or more recommended actions to the consumer via the consumer's communication device.

The credit management component 200 also can comprise a processor component 246 (PROCESSOR COMP. 246) that can work in conjunction with the other components (e.g., communication component 202, interface component 204, monitor component 206, etc.) to facilitate performing the various functions of the credit management component 200. The processor component 246 can employ one or more processors, microprocessors, or controllers that can process data, such as information (e.g., financial-related information, analytics-related information, etc.) relating to users associated with the open credit exchange platform, information relating to cryptography or authentication (e.g., information relating to defined security, cryptographic, and/or authentication protocols), information relating to other operations of the credit management component 200, and/or other information, etc., to facilitate operation of the credit management component 200, as more fully disclosed herein, and control data flow between the credit management component 200 and other components (e.g., other components of or associated with the credit management component 200).

The credit management component 200 also can include a data store 248 that can store data structures (e.g., user data, metadata), code structure(s) (e.g., modules, objects, hashes, classes, procedures) or instructions, information (e.g., financial-related information, analytics-related information, etc.) relating to users associated with the open credit exchange platform, information relating to cryptography or authentication (e.g., information relating to defined security, cryptographic, and/or authentication protocols), information relating to other operations of the credit management component 200, and/or other information, etc., to facilitate controlling operations associated with the credit management component 200. In an aspect, the processor component 246 can be functionally coupled (e.g., through a memory bus) to the data store 248 in order to store and retrieve information desired to operate and/or confer functionality, at least in part, to the communication component 202, interface component 204, monitor component 206, etc., and/or substantially any other operational aspects of the credit management component 200.

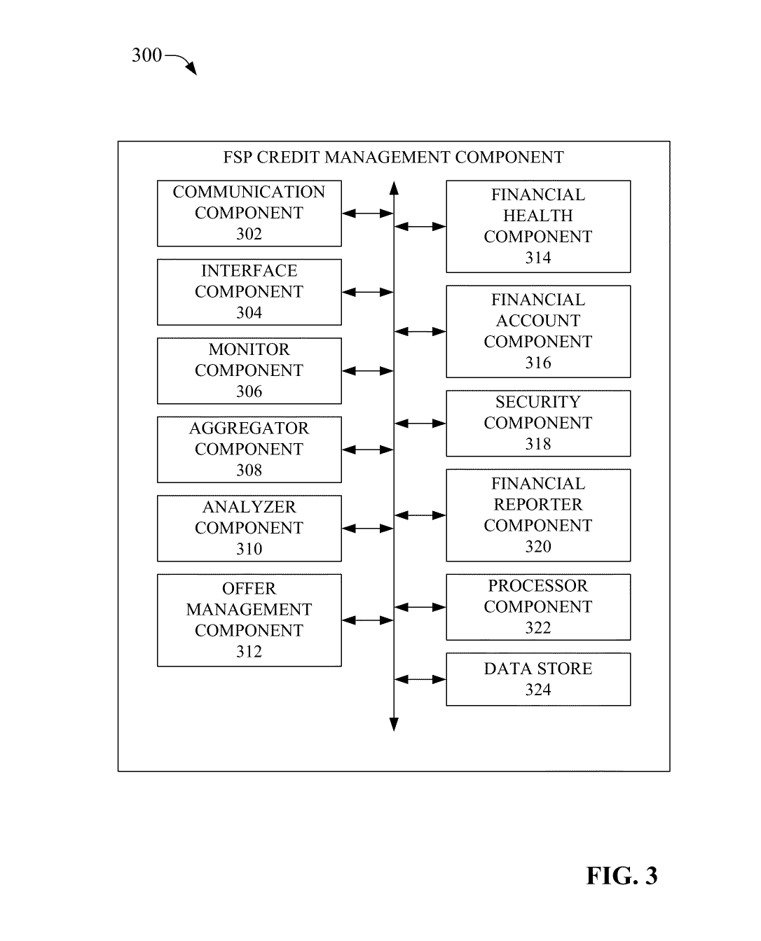

FIG. 3 illustrates a block diagram of an example FSP credit management component 300, in accordance with various aspects and embodiments of the disclosed subject matter. The FSP credit management component 300 can be associated with (e.g., communicatively connected to) an open credit exchange platform and/or communication devices associated with consumers, for example. The FSP credit management component 300 can be associated with, managed, operated, and/or utilized by a financial service provider.

The FSP credit management component 300 can comprise a communication component 302 that can communicate (e.g., transmit, receive) information, including financial-related information associated with the financial service provider and/or users (e.g., consumers), information relating to approved financial offers, and/or other information, between the FSP credit management component 300 and other components or devices, such as the open credit management platform (e.g., a communication device of or associated with the open credit management platform), communication devices associated with other financial service providers, communication devices associated with financial information providers, and/or communication devices associated with users. The communication component 302 can employ one or more communication protocols to facilitate controlling data or voice flows, and/or wireless or wireline communication of traffic (e.g., voice or data traffic), associated with the FSP credit management component 300.

The FSP credit management component 300 can include an interface component 304 that can comprise one or more interfaces, including one or more controls, switches, adapters, connectors, buttons, routers, speakers, display screens, GUIs, and/or touch screen GUIs, etc., that can facilitate enabling the FSP credit management component 300 to interface and/or communicate with other systems, components, or devices (e.g., open credit management platform; communication devices associated with consumers, financial service providers, or financial information providers; systems, components, or devices associated with a communication network(s); etc.), or users (e.g., system administrators, engineers, technicians, etc.) associated with the FSP credit management component 300 and/or the associated financial service provider. The interface component 304 can facilitate establishing a communication channel (e.g., a secure wireless or wireline communication channel) between the FSP credit management component 300 and the open credit management platform or a communication device associated with a consumer, another financial service provider, financial information provider, etc.

The FSP credit management component 300 can comprise a monitor component 306 that can monitor (e.g., continuously, periodically, dynamically (e.g., in response to a condition for monitoring information being met), etc.) information in real or near real time. The monitor component 306 can monitor, for example, financial-related information associated with respective consumers (e.g., as obtained from the open credit exchange platform, as directly obtained by the FSP credit management component 300, as obtained from communication devices of other financial service providers, as obtained from communication devices of financial information providers, as obtained from consumers (e.g., via communication devices of consumers), etc.). For instance, the open credit exchange platform can provide or make available the defined N financial-related parameters relating to one or more consumers to facilitate evaluation of financial-related information of the one or more consumers by the financial service provider(s). The monitor component 306 can monitor the financial-related parameters to facilitate updating the financial-related information of the one or more consumers in the data store 324, identifying a financial health or strength of a consumer, identifying an approved financial offer to be presented to a consumer, etc.

The FSP credit management component 300 also can contain an aggregator component 308 that can aggregate or collect the information (e.g., financial-related information, approved financial offers, consumer financial history, consumer preferences, etc.). For instance, the aggregator component 308 can aggregate information received (e.g., obtained) from various entities (e.g., open credit exchange platform, monitor component 306 or another component(s) of the FSP credit management component 300, communication network, an application (e.g., a mobile or web application), a server or other communication device, processor, data store, etc.). The aggregator component 308 can correlate respective items of data based at least in part on type of data (e.g., information relating to a particular financial transaction, information relating to a particular financial offer, metadata, etc.), consumer to which the data relates, source of the data, time or date the data was generated or received, etc., to facilitate analyzing or evaluating of the data by the analyzer component 310 or another component of the FSP credit management component 300.

The analyzer component 310 can analyze, evaluate, and/or parse information (e.g., financial-related information, defined financial assessment criteria, analytics feedback information, etc.) to facilitate identifying a financial health or strength of a consumer, identifying an approved financial offer to be presented to a consumer, modifying (e.g., updating) a user profile relating to a user (e.g., consumer), modifying an existing approved financial offer (e.g., to facilitate making the offer, or improving the chances of the offer being, a preferred approved financial offer), tailoring an approved financial offer (e.g., to facilitate making the offer, or improving the chances of the offer being, a preferred approved financial offer), etc. The analyzer component 310 can generate analysis results based at least in part on the analyzing, evaluating, and/or parsing of such information, and can provide the analysis results to another component(s) (e.g., offer management component 312, processor component 322, data store 324, etc.) for further processing.

The FSP credit management component 300 can comprise an offer management component 312 that, for respective consumers, can identify or evaluate financial-related information and/or the financial health associated with a consumer, and can identify one or more approved financial offers that can be directed to the consumer, based at least in part on the financial-related information and/or the financial health associated with the consumer. For instance, the offer management component 312 can receive the analysis results from the analyzer component 310, and can evaluate the analysis results. The offer management component 312 can identify and select (e.g., automatically or dynamically identify and select) the one or more approved financial offers that can be made to the consumer, based at least in part on the evaluation of the analysis results, in accordance with the defined financial assessment criteria associated with the financial service provider. The offer management component 312 also can generate contracts, comprising the contract terms, associated with the approved financial offers, wherein a contract can be provided or presented (e.g., by the FSP credit management component 300 or the open credit exchange platform) with an approved financial offer or in response to acceptance of the approved financial offer by the consumer. The FSP credit management component 300, using the communication component 302 and/or another component(s), can facilitate communicating the one or more approved financial offers to, for example, the open credit exchange platform.

The offer management component 312 also can facilitate modifying existing approved financial offers or tailoring approved financial offers based at least in part on analytics feedback information received from the open credit exchange platform, as more fully disclosed herein. For example, the offer management component 312 can analyze analytics feedback information received from the open credit exchange platform in connection with approved financial offers that the financial service provider has submitted via the open credit exchange platform. The offer management component 312 can facilitate modifying an existing approved financial offer(s) or tailoring a newly created approved financial offer(s) based at least in part on the analytics feedback information.

The FSP credit management component 300 also can include a financial health component 314 that, for respective consumers, can identify a financial health or strength of a consumer. The financial health component 314 can identify the financial health or strength of a consumer, based at least in part on its own analysis or evaluation of financial-related information associated with a consumer (or that of another component (e.g., the analyzer component 310) of the FSP credit management component 300), a financial health or strength assessment or score from the open credit exchange platform, and/or a financial health or strength assessment or score from another entity (e.g., a financial information provider).

The FSP credit management component 300 also can contain a financial account component 316 that can collect, manage, and secure data (e.g., financial-related information) associated with consumers who are associated with (e.g., registered with, engaged in business with, potentially engaged in business with, etc.) the financial service provider associated with the FSP credit management component 300. For instance, the financial account component 316 can facilitate maintaining respective account information (e.g., financial account information, such as account number, outstanding balance, payment history, monthly payment amount, interest rate, etc.) of respective users (e.g., consumers), applying monetary payments to or withdrawing monetary funds from a financial account of a user (e.g., in accordance with an accepted approved financial offer), adjusting a credit line or financial terms associated with a financial account of a user, etc. The financial account component 316 can create and manage respective user profiles or accounts for respective consumers, and the respective user profiled or accounts can be stored in the data store 324.

The FSP credit management component 300 also can include a security component 318 that can secure data associated with the FSP credit management component 300. The security component 318 can operate in conjunction with the communication component 302 to establish a secure communication channel between the FSP credit management component 300 and the open credit exchange platform or communication devices associated with users (e.g., consumers, financial service providers, financial information providers, etc.), in accordance with a defined security protocol(s) and defined security criteria. For example, the security component 318 can establish a secure communication channel in accordance with an SSL protocol and/or other cryptographic protocol. The security component 318 can encrypt data that is to be transmitted to a communication device, and can decrypt encrypted data received from a communication device, in accordance with an appropriate cryptographic protocol(s) (e.g., a protocol(s) relating to data encryption and decryption, public key cryptography, symmetric key, PKI, DSS, DES, triple-DES, AES, cryptographic hash functions, etc.).

The security component 318 also can utilize authentication protocols to authenticate communication devices and associated users attempting to access the FSP credit management component 300. For example, the security component 318 can control access to the FSP credit management component 300 based at least in part on verification of authentication credentials provided by communication devices of the open credit exchange platform and/or users. The security component 318 can grant certain access rights to a communication device of a user in response to verifying the authentication credentials presented by the communication device of the user, wherein the access rights granted can be based at least in part on the particular user (e.g., type of user, such as a user associated with the open credit management platform, a consumer, a financial service provider, a financial information provider, etc.), the authentication credentials presented, and/or the defined security criteria. For example, in accordance with the defined security criteria, the security component 318 can grant a consumer (and associated communication device), who is registered with the FSP credit management component 300, a first subset of access rights to the FSP credit management component 300, and grant a user, who is associated with the open credit exchange platform (and associated communication device) that is associated with the FSP credit management component 300, a second subset of access rights to the FSP credit management component 300. Authentication credentials can include or be based at least in part on, for example, a username, a password, a PIN, biometric information (e.g., fingerprint information, eye or iris related information, facial recognition related information, etc.) associated with a user, a communication device identifier (e.g., MAC address) associated with a communication device, etc. In some implementations, the security component 318 can use a random or pseudo-random number generator component that can generate (e.g., randomly or pseudo-randomly generate) random or pseudo-random numbers, which can be used to facilitate securing data, in accordance with the defined security criteria.

The FSP credit management component 300 can contain a financial reporter component 320 that can facilitate reporting of information (e.g., financial-related information) to the open credit exchange platform or another component(s) (e.g., communication device associated with a financial service provider, financial information provider, or other entity) associated with the FSP credit management component 300. For instance, the financial reporter component 320 can provide and/or update information relating to a consumer to the open credit exchange platform to facilitate enabling the open credit exchange platform to identify or update financial-related information relating to the consumer, identify or update a financial health or strength of the consumer, identify or update information relating to a financial account of the consumer, etc.

The FSP credit management component 300 also can comprise a processor component 322 that can work in conjunction with the other components (e.g., communication component 302, interface component 304, monitor component 306, etc.) to facilitate performing the various functions of the FSP credit management component 300. The processor component 322 can employ one or more processors, microprocessors, or controllers that can process data, such as information (e.g., financial-related information) relating to users associated with the FSP credit management component 300, information relating to determinations regarding whether to issue an approved financial offer, information relating to determination of the terms of an approved financial offer, information relating to cryptography or authentication (e.g., information relating to defined security, cryptographic, and/or authentication protocols), information relating to the defined financial assessment criteria, information relating to the defined security criteria, information relating to other operations of the FSP credit management component 300, and/or other information, etc., to facilitate operation of the FSP credit management component 300, as more fully disclosed herein, and control data flow between the FSP credit management component 300 and other components (e.g., other components of or associated with the FSP credit management component 300).

The FSP credit management component 300 also can include a data store 324 that can store data structures (e.g., user data, metadata), code structure(s) (e.g., modules, objects, hashes, classes, procedures) or instructions, information relating to determinations regarding whether to issue an approved financial offer, information relating to determination of the terms of an approved financial offer, information relating to cryptography or authentication (e.g., information relating to defined security, cryptographic, and/or authentication protocols), information relating to the defined financial assessment criteria, information relating to the defined security criteria, information relating to other operations of the FSP credit management component 300, and/or other information, etc., to facilitate controlling operations associated with the FSP credit management component 300. In an aspect, the processor component 322 can be functionally coupled (e.g., through a memory bus) to the data store 324 in order to store and retrieve information desired to operate and/or confer functionality, at least in part, to the communication component 302, interface component 304, monitor component 306, etc., and/or substantially any other operational aspects of the FSP credit management component 300.

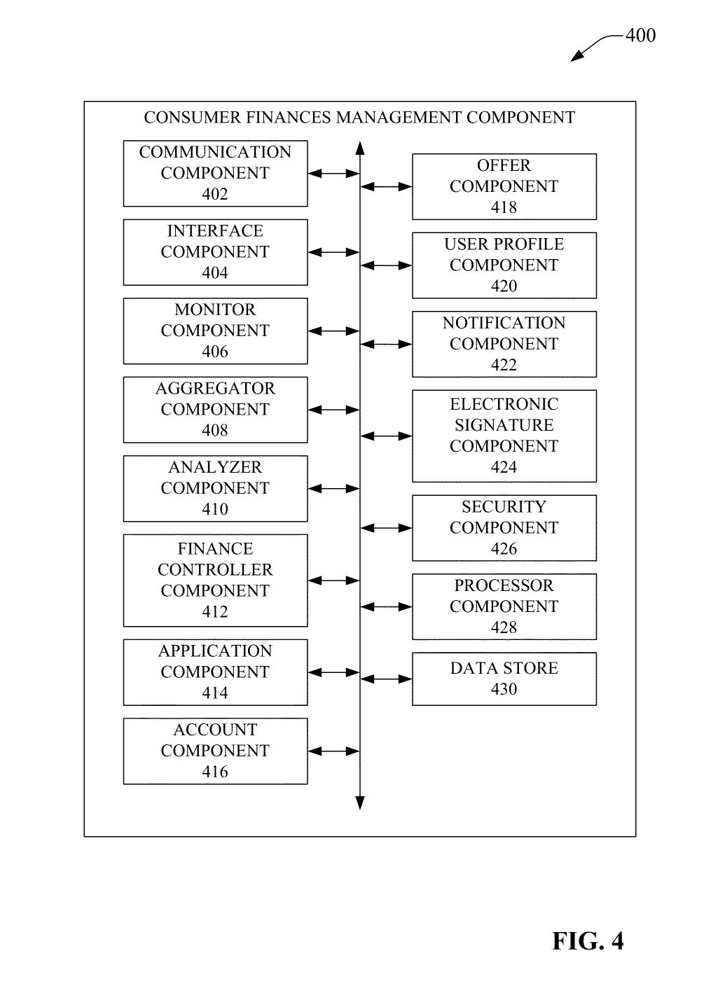

FIG. 4 depicts a block diagram of an example consumer finances management component 400 in accordance with various aspects and embodiments of the disclosed subject matter. The consumer finances management component 400 can be part of or associated with a communication device (e.g., mobile phone, computer, etc.) associated with a user (e.g., consumer). In some implementations, various aspects or functions of the consumer finances management component 400 can be facilitated using an application (e.g., a locally based or mobile application, a web based application).

The consumer finances management component 400 can comprise a communication component 402 that can communicate (e.g., transmit, receive) information, including financial-related information associated with a user (e.g., consumer), information relating to approved financial offers or associated contracts, and/or other information, between the consumer finances management component 400 and other components or devices, such as the open credit management platform (e.g., a communication device of or associated with the open credit management platform), communication devices associated with financial service providers, and/or communication devices associated with financial information providers. The communication component 402 can employ one or more communication protocols to facilitate controlling data or voice flows, and/or wireless or wireline communication of traffic (e.g., voice or data traffic), associated with the consumer finances management component 400.

The consumer finances management component 400 can include an interface component 404 that can comprise one or more interfaces, including one or more controls, switches, adapters, connectors, buttons, routers, speakers, display screens, GUIs, and/or touch screen GUIs, etc., that can facilitate enabling the consumer finances management component 400 to interface and/or communicate with other systems, components, or devices (e.g., open credit management platform; communication devices associated with financial service providers or financial information providers; systems, components, or devices associated with a communication network(s); etc.). The interface component 404 can facilitate establishing a communication channel (e.g., a secure wireless or wireline communication channel) between the consumer finances management component 400 and the open credit management platform or a communication device associated with a financial service provider, financial information provider, etc.

The consumer finances management component 400 can comprise a monitor component 406 that can monitor (e.g., continuously, periodically, dynamically (e.g., in response to a condition for monitoring information being met)) information in real or near real time. The monitor component 406 can monitor information communications to facilitate detecting and identifying, for example, financial-related information, including approved financial offers, contracts relating to approved financial offers, notifications relating to approved financial offers, notifications relating to refinancing of a financial account(s) or debt(s) of a user of the communication device, notifications relating to financial strength or health of the user, etc. For instance, the monitor component 406 can be monitoring information communications associated with the communication device, comprising the consumer finances management component 400. The monitor component 406 can identify or detect an approved financial offer being made to the user associated with the communication device or a notification relating to financial-related information associated with the user and can facilitate providing information relating to the approved financial offer or the notification to the user via an interface(s) associated with the interface component 404.

The consumer finances management component 400 also can contain an aggregator component 408 that can aggregate or collect information (e.g., financial-related information, approved financial offers, user preferences, etc.) received or maintained by the communication device. For instance, the aggregator component 408 can aggregate information received (e.g., obtained) from various entities (e.g., open credit exchange platform, monitor component 406 or another component(s) of the consumer finances management component 400, communication network, an application (e.g., a mobile or web application), a server or other communication device, processor, data store, etc.). The aggregator component 408 can correlate respective items of data based at least in part on type of data (e.g., information relating to a particular financial transaction, information relating to a particular approved financial offer, metadata, etc.), source of the data, time or date the data was generated or received, etc., to facilitate analyzing or evaluating of the data by the analyzer component 410 or another component of the consumer finances management component 400.

The analyzer component 410 can analyze, evaluate, and/or parse information (e.g., financial-related information, etc.) associated with the user (e.g., consumer) to facilitate identifying current assets and debts (e.g., identifying total assets and debts, identifying a subset of assets and debts), modifying (e.g., updating) a user profile relating to the user, identifying a financial health or strength of a consumer, etc. The analyzer component 410 can generate analysis results based at least in part on the analyzing, evaluating, and/or parsing of such information, and can provide the analysis results to another component(s) (e.g., finance controller component 412, processor component 428, data store 430, etc.) for further processing.

The consumer finances management component 400 also can comprise a finance controller component 412 that can control operations associated with the various components of the consumer finances management component 400. For instance, the finance controller component 412 can control operations of the consumer finances management component 400 to facilitate identifying and presenting approved financial offers, contracts associated with approved financial offers, electronic signatures relating to such contracts, notifications relating financial-related information, etc., by the consumer finances management component 400 to facilitate presentation of such information to the user of the communication device. The finance controller component 412 also can facilitate controlling data flow between the various components (e.g., communication component 402, interface component 404, monitor component 406, etc.) of the consumer finances management component 400 to facilitate performing the various operations of the consumer finances management component 400.

The consumer finances management component 400 also can include an application component 414 that can comprise an application(s) (e.g., financial application) that can be utilized by the communication device to facilitate interaction (e.g., communication of financial-related information) between the communication device and the open credit exchange platform, financial service providers, financial information providers, etc., creating and maintaining a digital wallet associated with the user of the communication device, executing (e.g., electronic signing and accepting) of contracts relating to approved financial offers, debt monitoring associated with the user, monitoring of financial health or strength associated with the user, monitoring of credit history associated with the user, etc. For instance, the application component 414 can facilitate generating a digital wallet that can aggregate all or a desired portion of financial accounts (e.g., bank accounts, credit accounts, loan accounts, etc.) and available approved financial offers for presentation of information relating to these financial accounts and approved financial offers to the user (e.g., via an interface associated with the application component 414).

The consumer finances management component 400 can comprise an account component 416 that can maintain information relating to the financial accounts and available approved financial offers for presentation of information relating to these financial accounts and approved financial offers. The account component 416 can comprise the digital wallet, for example. The digital wallet can contain and present information relating to the assets and debts of the user, and approved financial offers available to the user. The account component 416 can be generated based at least in part by using an application(s) associated with the application component 414.

The consumer finances management component 400 can contain an offer component 418 that can facilitate managing financial offers, such as approved financial offers, being presented to the user associated with the communication device by the open credit exchange platform and/or a financial service provider. The offer component 418 can provide (e.g., present) the terms (e.g., amount of funds available, interest rate, fee(s), installment payment amount, repayment period, etc.) of an approved financial offer, a contract relating to the approved financial offer, and/or other information relating to the approved financial offer. In some implementations, the offer component 418 can provide the approved financial offers in a standardized format to facilitate making it easier for the user to comprehend the respective terms of approved financial offers and/or making it easier for the user to compare different approved financial offers with each other.

The consumer finances management component 400 can include a user profile component 420 that can be employed to generate a user profile for the user associated with the communication device. The user profile can include financial-related information associated with the user, identifying information associated with the user, user preferences associated with the user, etc. For example, the user profile can include user preferences that can specify criteria (e.g., financial offer related criteria) of the user that can facilitate managing presentation of approved financial offers, refinancing of debts associated with the user, etc. The user profile also can include user preferences relating to privacy or security of information relating to the user. For instance, the user profile component 420 can include user preferences relating to information security that can facilitate controlling what information of the user is exposed to the open credit exchange platform, financial service providers, financial information providers, etc.

The consumer finances management component 400 can comprise a notification component 422 that can facilitate generating and/or presenting of notifications relating to approved financial offers, refinancing of debts (e.g., refinancing of a loan(s)), financial health or strength, improving the financial health or strength, etc., associated with the user. The notification component 422 can receive notification messages from, for example, the open credit exchange platform, wherein the notification messages can notify the user of an approved financial offer being extended to the user by a financial service provider, notify the user of a refinancing of debts of the user (e.g., performed by the open credit exchange platform) or an opportunity to refinance debts of the user, notify the user of a change in the financial health or strength of the user, notify the user of instructions to facilitate improving the financial health or strength of the user, etc. The notification component 422 can generate and present (e.g., via an interface(s) of the user's communication device) a notification or alert signal (e.g., message; audial, visual, or other sensory indicator (e.g., vibration of the user's communication device); etc.), based at least in part on, and in response to, the notification message received from the open credit exchange platform, in accordance, for example, with the user preferences of the user. The notification component 422 can generate respective (e.g., different) types of notifications or alerts based at least in part on the type of notification message received from the open credit exchange platform. For example, the notification component 422 can generate and present a first type of alert (e.g., first type of visual, audial, and/or other sensory alert) for a first type of notification (e.g., a notification relating to an approved financial offer), and a second type of alert (e.g., second type of visual, audial, and/or other sensory alert) for a second type of notification (e.g., a notification relating to a change in the financial health or strength of the user).

The consumer finances management component 400 can contain an electronic signature component 424 that can facilitate enabling the user to electronically sign contracts (e.g., electronic document comprising a contract) relating to approved financial offers that are being accepted by the user and/or other electronic documents for which an electronic signature is desired or required. An electronically signed contract can be a legally binding contract between the user and the financial service provider that made the approved financial offer. In some implementations, the electronic signature component 424 can operate in conjunction with the security component 426 to facilitate applying an electronic signature to an electronic document (e.g., contract) in a secure manner, ensuring that the electronic signature is actually being made by the user or other authorized entity (e.g., using an authentication protocol(s)), etc.

The consumer finances management component 400 can include a security component 426 that can secure data associated with the consumer finances management component 400. In some implementations, the security component 426 can facilitate controlling what information of the user is exposed to the open credit exchange platform, financial service providers, financial information providers, etc., in accordance with user preferences contained in the user profile of the user or dynamically selected user preferences of the user. The security component 426 can operate in conjunction with the communication component 402 to establish a secure communication channel between the communication device and the open credit exchange platform and/or communication devices associated with financial service providers, financial information providers, etc., in accordance with a defined security protocol(s) and defined security criteria. For example, the security component 426 can establish a secure communication channel in accordance with an SSL protocol and/or other cryptographic protocol. The security component 426 can encrypt data that is to be transmitted to a communication device, and can decrypt encrypted data received from a communication device, in accordance with an appropriate cryptographic protocol (e.g., a protocol relating to data encryption and decryption, public key cryptography, symmetric key, PKI, DSS, DES, triple-DES, AES, cryptographic hash functions, etc.).

In some implementations, the security component 426 can employ a defined authentication protocol(s) to facilitate authenticating an entity (e.g., a user) attempting to access the application, securing the digital wallet (and information or accounts therein) and authenticating an entity attempting to access the digital wallet, authenticating an entity attempting to apply a digital signature to an electronic document, etc. For example, the security component 426 can control access to the application or digital wallet, and/or control applying of an electronic signature to an electronic document, based at least in part on authentication information (e.g., authentication credentials) received from an entity, in accordance with a defined authentication protocol. If the security component 426 verifies the received authentication information in relation to stored authentication information associated with the entity (e.g., if the received authentication information matches the stored authentication information), the security component 426 can grant a subset of access rights to the application or digital wallet to the entity, or apply an electronic signature of the entity to the electronic document, in accordance with the defined authentication protocol. If the security component 426 is not able to verify the received authentication information in relation to the stored authentication information associated with the entity (e.g., if the received authentication information does not match the stored authentication information), the security component 426 can deny access rights to the application or digital wallet to the entity, or can deny application of an electronic signature of the entity to the electronic document, in accordance with the defined authentication protocol.

The consumer finances management component 400 also can comprise a processor component 428 that can work in conjunction with the other components (e.g., communication component 402, interface component 404, monitor component 406, etc.) to facilitate performing the various functions of the consumer finances management component 400. The processor component 428 can employ one or more processors, microprocessors, or controllers that can process data, such as information (e.g., financial-related information) relating to a user(s) associated with the consumer finances management component 400, information relating to user preferences, information relating to cryptography or authentication (e.g., information relating to defined security, cryptographic, and/or authentication protocols), information relating to the defined financial offer criteria, information relating to the defined security criteria, information relating to other operations of the consumer finances management component 400, and/or other information, etc., to facilitate operation of the consumer finances management component 400, as more fully disclosed herein, and control data flow between the consumer finances management component 400 and other components (e.g., other components of or associated with the consumer finances management component 400).

The consumer finances management component 400 also can include a data store 430 that can store data structures (e.g., user data, metadata), code structure(s) (e.g., modules, objects, hashes, classes, procedures) or instructions, information (e.g., financial-related information) relating to a user(s) associated with the consumer finances management component 400, information relating to user preferences, information relating to cryptography or authentication (e.g., information relating to defined security, cryptographic, and/or authentication protocols), information relating to the defined financial offer criteria, information relating to the defined security criteria, information relating to other operations of the consumer finances management component 400, and/or other information, etc., to facilitate controlling operations associated with the consumer finances management component 400. In an aspect, the processor component 428 can be functionally coupled (e.g., through a memory bus) to the data store 430 in order to store and retrieve information desired to operate and/or confer functionality, at least in part, to the communication component 402, interface component 404, monitor component 406, etc., and/or substantially any other operational aspects of the consumer finances management component 400.

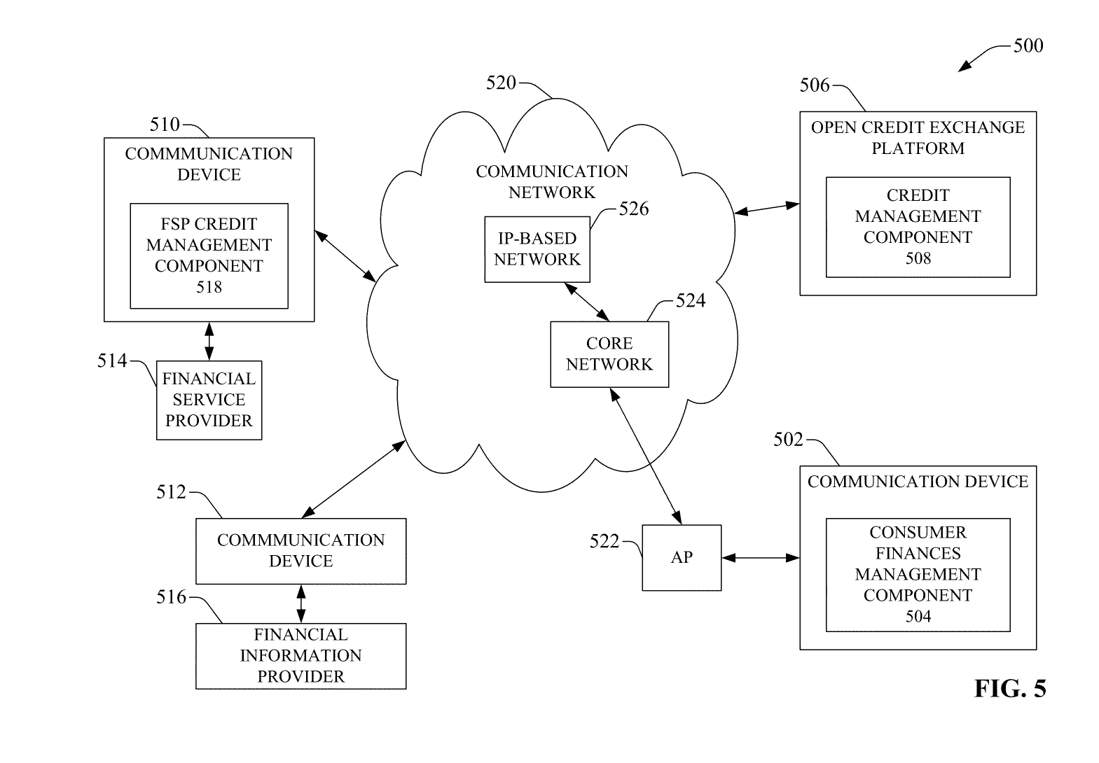

FIG. 5 illustrates a diagram of an example system 500 that can facilitate managing participation of market participants in a credit exchange, providing (e.g., in real or near real time) analytics feedback information regarding respective financial offers of respective financial service providers, and providing (e.g., in real or near real time) automated real-time approved financial offers (e.g., a preferred approved financial offer(s)) to communication devices associated with users (e.g., consumers), in accordance with various aspects and embodiments described herein. In an aspect, the system 500 can include a communication device 502 that can communicate (e.g., voice, data) other communication devices associated with the system 500 in a communication network environment. The communication device can include a consumer finances management component 504 that can facilitate enabling a user (e.g., consumer) to monitor, manage, execute, etc., financial transactions associated with the user, as more fully disclosed herein.

The system 500 can include an open credit exchange platform 506, which can include a credit management component 508 that can manage and process financial transactions associated with consumers and financial service providers, identify and select approved financial offers (e.g., best or most preferred approved financial offer(s)) for presentation to consumers, refinance an account(s) associated with a consumer, collect financial-related information associated with consumers, assess the financial health of a user, make certain financial-related information available to financial service providers, instruct the consumer as to how to improve the consumer's financial health, register users (e.g., consumers, financial service providers, financial information providers, other information providers, etc.) with the open credit exchange platform 506, and/or perform other functions, as more fully disclosed herein. The open credit exchange platform 506 be or can comprise a communication device and can communicate with other communication devices, such as communication device 502, associated with the system 500 in the communication network environment.

The system 500 also can contain one or more other communication devices, including communication device 510 and communication device 512, which can be respectively associated with one or more financial service providers, such as financial service provider 514, and one or more financial information providers, such as financial information provider 516. The financial service provider(s) 514 can provide financial services (e.g., bank accounts, loans, credit accounts, etc.) to consumers. The communication device 510 associated with the financial service provider 514 can include an FSP credit management component 518 that can manage financial transactions and financial accounts associated with consumers, evaluate the financial strength and/or creditworthiness of consumers, generate approved financial offers that can be presented to users (e.g., in accordance with the defined financial assessment criteria associated with the financial service provider 514), and/or perform other functions, as more fully disclosed herein. The financial information provider(s) 516 can collect information relating to consumers and/or financial service providers, and can provide that information to other entities, such as the open credit exchange platform 506, consumers, financial service providers, etc.

The system 500 can comprise a communication network 520 that can be employed to facilitate communication of voice and data between the communication device 502, the open credit exchange platform 506, communication device 510, communication device 512, or other communication devices associated with the communication network 520. Each of the communication devices (e.g., communication device 502, communication device associated with the open credit exchange platform 506, communication device 510, communication device 512, etc.) can connect to the communication network 520 via a wireline or wireless communication connection. The communication network 520 can comprise or be associated with a number of access points (APs) (e.g., base station), including AP 522, wherein the AP 522 can facilitate wireless connection of a communication device (e.g., 502) with the communication network 520, when a wireless communication connection is desired.

In accordance with various aspects, as a communication device (e.g., 502) is moved through a wireless communication network environment, at various times, the communication device can be connected (e.g., wirelessly connected) to one of a plurality of APs (e.g., macro or cellular AP, femto AP, pico AP, Wi-Fi AP, Wi-Max AP, etc.), such as the AP 522, that can operate in the wireless communication network environment. An AP (e.g., 522) can serve a specified coverage area to facilitate communication by the communication device or other communication devices in the wireless communication network environment. The AP can serve a respective coverage cell (e.g., macrocell, femtocell, picocell, etc.) that can cover a respective specified area, and the AP can service mobile wireless devices (e.g., communication device 502) located in the respective area covered by the respective cell, where such coverage can be achieved via a wireless link (e.g., uplink (UL), downlink (DL)). When an attachment attempt is successful, the communication device can be served by the AP and incoming voice and data traffic can be paged and routed to the communication device through the AP, and outgoing voice and data traffic from the communication device can be paged and routed through the AP to other communication devices in the communication network environment. In an aspect, the communication device can be connected and can communicate wirelessly using virtually any desired wireless technology, including, for example, cellular, Wi-Fi, Wi-Max, wireless local area networks (WLAN), etc.

In another aspect, the communication network 520 can comprise a core network 524 (e.g., mobile core network) that can be employed to facilitate communication (e.g., voice, data) by wireless communication devices (e.g., 502) associated (e.g., wirelessly connected) with the core network 524, via the AP 522, and other communication devices (e.g., communication device associated with the open credit exchange platform 506, communication device 510, communication device 512, etc.) associated with the communication network 520. The core network 524 can facilitate routing voice and data communications between communication devices (e.g., communication device 502, communication device associated with the open credit exchange platform 506, communication device 510, communication device 512, and/or communication devices associated with an IP-based network 526 (e.g., the Internet)) associated with the communication network 520. The core network 524 also can allocate resources to the a wireless communication device(s) (e.g., 502) associated with the core network 524, convert or enforce protocols, establish and enforce Quality of Service (QoS) for the wireless communication devices, provide applications or services in the network, translate signals, and/or perform other desired functions to facilitate system interoperability and communication in the wireless communication network. The core network 524 further can include desired components, such as routers, nodes, switches, interfaces, controllers, etc., that can facilitate communication of data between communication devices associated with the communication network 520.

The communication network 520 also can include the IP-based network 526 that can be associated with the core network 524 and can facilitate communications by communication devices associated with the communication network 520 at least in part via communication of data packets (e.g., IP-based data packets) between communication devices that are associated with the communication network 520 using a wired or wireless communication connection in accordance with specified IP protocols. The IP-based network 526 further can include desired components, such as routers, nodes, switches, interfaces, controllers, etc., that can facilitate communication of data between communication devices associated with the communication network 520. In an aspect, a wireline communication connection between a communication device (e.g., communication device 502, communication device associated with the open credit exchange platform 506, communication device 510, communication device 512, etc.) and the IP-based network 526 can be a communication connection that can communicate voice or data, and/or can be a DSL-type or broadband connection facilitated via an Ethernet connection, and/or a wireless communication connection can be facilitated via a connection of the wireless communication device (e.g., 502) to an AP (e.g., 522). In accordance with various aspects, a communication device can transmit voice calls or data (e.g., messages) via a wireline or wireless connection through the IP-based network 526, the core network 524, or other communication networks, to another communication device(s).

In accordance with yet another aspect, the communication device 502 and another communication device (e.g., communication device associated with the open credit exchange platform 506, communication device 510, etc.) can establish a direct communication channel with each other to exchange information, such as information relating to a financial transaction (e.g., purchase of a product or service, transaction relating to an approved financial offer, etc.), using NFC or other communication technology, as more fully described herein.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

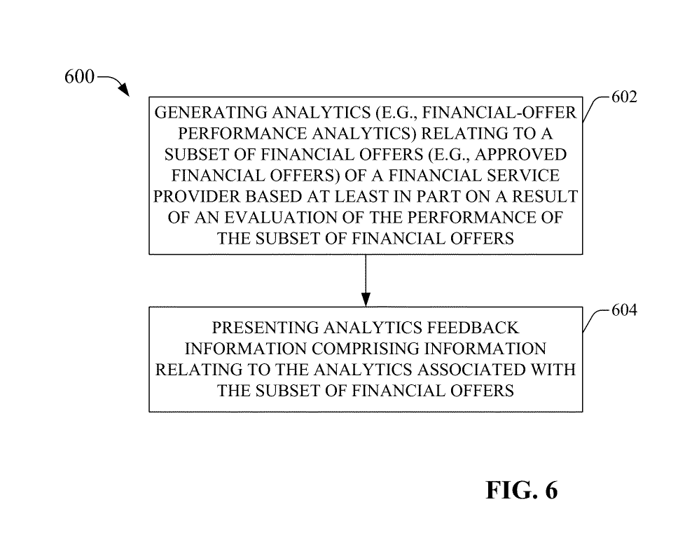

In view of the example systems described above, example methods that can be implemented in accordance with the disclosed subject matter can be better appreciated with reference to flowcharts in FIGS. 6-9. For purposes of simplicity of explanation, various methods disclosed herein are presented and described as a series of acts; however, it is to be understood and appreciated that the subject disclosure is not limited by the order of acts, as some acts may occur in different order and/or concurrently with other acts from that shown and described herein. It is noted that not all illustrated acts may be required to implement a described method in accordance with the subject specification. In addition, for example, one or more methods disclosed herein could alternatively be represented as a series of interrelated states or events, such as in a state diagram. Moreover, interaction diagram(s) or call flow(s) represent several of the example methods disclosed herein in accordance with the described subject matter; particularly in instances when disparate entities, or functional elements, enact disparate portions of one or more of the several methods. Furthermore, two or more of the disclosed example methods can be implemented in combination, to accomplish one or more features or advantages described in the subject disclosure.

With reference to FIG. 6, illustrated is a flow chart of an example method 600 that can facilitate presenting (e.g., in real or near real time) analytics feedback information relating to a subset of financial offers of a financial service provider to the financial service provider, in accordance with various aspects and embodiments of the disclosed subject matter. The method 600 can be utilized, for example, by the open credit exchange platform (e.g., by a credit management component of the open credit exchange platform). The open credit exchange platform can perform all or at least a portion of the operations of the method 600 in real time or at least near real time, automatically, and/or dynamically (e.g., in response to a triggering event occurring).

At 602, analytics (e.g., financial-offer performance analytics) relating to a subset of financial offers (e.g., approved financial offers) of a financial service provider can be generated based at least in part on a result of an evaluation of the performance of the subset of financial offers. The credit management component can generate the analytics relating to the subset of financial offers of the financial service provider based at least in part on a result of an evaluation of the performance of the subset of financial offers. The credit management component can monitor and track the performance of financial offers of respective financial service providers. For instance, the credit management component can track the performance of the subset of financial offers of the financial service providers relative to same or similar financial offers of other financial service providers and/or relative to various credit groups (e.g., respective credit groups associated with respective ranges of financial health scores and/or satisfying respective defined credit criterion(s)). The analytics can include, for example, those analytics (e.g., number of financial offers selected as preferred, number of financial offers accepted by consumers, other analytics of performance of financial offers relative to various credit groups and/or relative to financial offers of other financial service providers) as have been more fully disclosed herein.

At 604, analytics feedback information comprising information relating to the analytics associated with the subset of financial offers can be presented (e.g., to a communication device or destination address associated with the financial service provider). The credit management component can present the analytics feedback information associated with a financial service provider to a communication device or destination address associated with the financial service provider. The credit management component can present the analytics feedback information via one or more interfaces of the open credit exchange platform, via a message (e.g., notification message) communicated to the communication device or destination address associated with the financial service provider, or via another means of presenting the analytics feedback information.

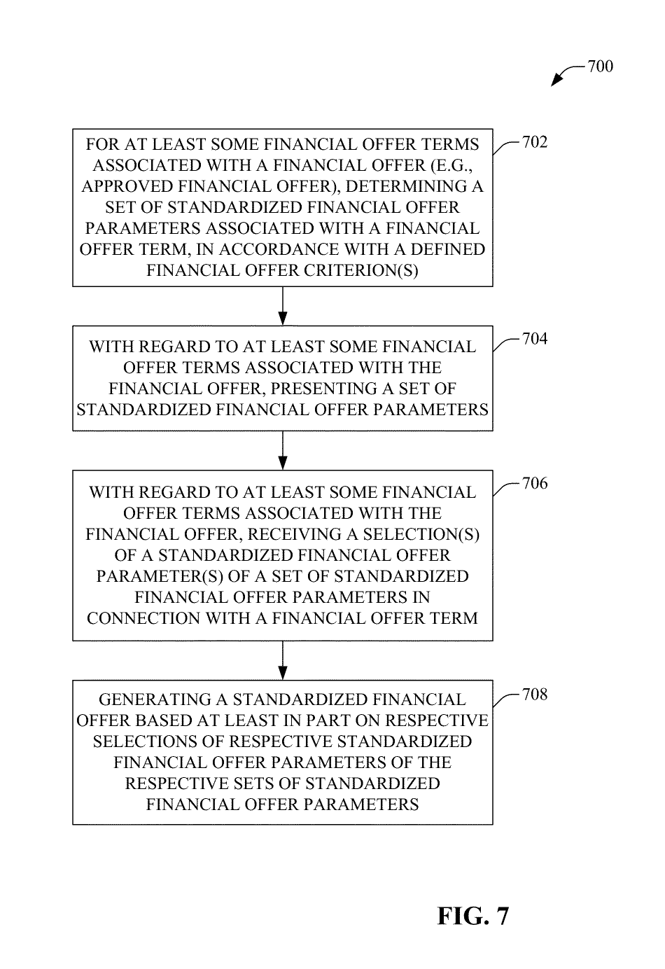

Referring to FIG. 7, depicted is a flow chart of an example method 700 that can facilitate standardizing a financial offer (e.g., an approved financial offer), in accordance with various aspects and embodiments of the disclosed subject matter. The method 700 can be utilized, for example, by the open credit exchange platform (e.g., by a credit management component of the open credit exchange platform).

At 702, for each or at least some financial offer terms associated with a financial offer (e.g., approved financial offer), a set of standardized financial offer parameters associated with a financial offer term can be determined, in accordance with a defined financial offer criterion(s). For each or at least some financial offer terms associated with the financial offer, the credit management component can determine a set of standardized financial offer parameters associated with a financial offer term, in accordance with the defined financial offer criterion(s). For example, with regard to a particular type of financial offer (e.g., a mortgage loan offer, a car loan, a line of credit, etc.), the credit management component can identify a first set of standardized financial offer parameters (e.g., 3, 3.5, 4, 4.5, 5 years, or another desired time period(s)) in connection with a first financial offer term (e.g., a repayment period) associated with the financial offer, identify a second set of standardized financial offer parameters (e.g., an interest rate of 3.0%, 3.5%, 4.0%, 4.5%, 5%, or another desired interest rate(s)) in connection with a second financial offer term (e.g., an interest rate) associated with the financial offer, and/or identify another set(s) of standardized financial offer parameters in connection with another financial offer term(s) associated with the financial offer, in accordance with the defined financial offer criterion(s).

At 704, with regard to each or at least some financial offer terms associated with the financial offer, a set of standardized financial offer parameters can be presented. For instance, for each or at least some financial offer terms associated with the financial offer, the credit management component can present a set of standardized financial offer parameters via the open credit exchange platform for use by financial service providers associated with the open credit exchange platform to facilitate creating financial offers (e.g., approved financial offers).

At 706, with regard to each or at least some financial offer terms associated with the financial offer, a selection(s) of a standardized financial offer parameter(s) of a set of standardized financial offer parameters in connection with a financial offer term of the financial offer can be received. For instance, for each or at least some financial offer terms associated with the financial offer, the credit management component can receive the selection of a standardized financial offer parameter (e.g., 4 years) of a set of standardized financial offer parameters (e.g., 3, 3.5, 4, 4.5, 5 years, or another desired time period(s)) in connection with a financial offer term (e.g., a repayment period) of the financial offer from a communication device associated with a financial service provider that is accessing the open credit exchange platform to generate an approved financial offer that can be presented to a consumer or group of consumers (e.g., credit or financial group of consumers) via the open credit exchange platform.

At 708, a standardized financial offer can be generated based at least in part on respective selections of respective standardized financial offer parameters of the respective sets of standardized financial offer parameters. The credit management component can facilitate generating the standardized financial offer (e.g., standardized approved financial offer) based at least in part on respective selections of respective standardized financial offer parameters of the respective sets of standardized financial offer parameters.

As more fully disclosed herein, the credit management component can further process the standardized financial offer associated with a financial service provider to facilitate determining whether the standardized financial offer is to be presented to a consumer(s) via a communication device(s) or destination address(es) associated with the consumer(s). For example, the credit management component can compare the standardized approved financial offer of the financial service provider with one or more other standardized approved financial offers of one or more other financial service providers to facilitate determining whether the standardized approved financial offer of the financial service provider is the preferred standardized approved financial offer relative to the other standardized approved financial offers. If the credit management component determines that the standardized approved financial offer of the financial service provider is the preferred standardized approved financial offer relative to the other standardized approved financial offers, the credit management component can notify the consumer, via the consumer's communication device or destination address, of the preferred standardized approved financial offer.

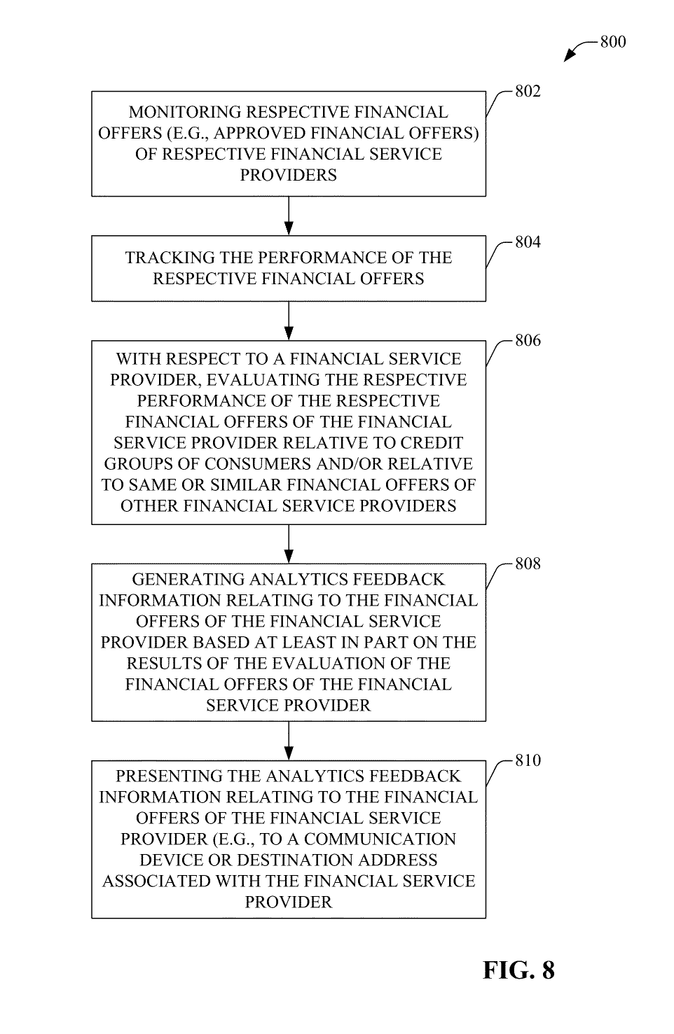

FIG. 8 presents a flow chart of an example method 800 that can facilitate providing (e.g., in real or near real time) analytics feedback information relating to one or more financial offers of a financial service provider to the financial service provider, in accordance with various aspects and embodiments of the disclosed subject matter. The method 800 can be utilized, for example, by the open credit exchange platform (e.g., by a credit management component of the open credit exchange platform). The open credit exchange platform can perform all or at least a portion of the operations of the method 800 in real time or at least near real time, automatically, and/or dynamically (e.g., in response to a triggering event occurring).

At 802, respective financial offers (e.g., approved financial offers) of respective financial service providers can be monitored (e.g., in real or at least near real time). The credit management component can monitor respective financial offers of respective financial service providers associated with the open credit exchange platform.

At 804, the performance of the respective financial offers can be tracked (e.g., in real or at least near real time). The credit management component can track the respective performance of the respective financial offers of the respective financial service providers. For instance, the credit management component can track the performance of one or more respective financial offers of a financial service provider relative to other respective financial offers (e.g., respectively same or similar financial offers) of other financial service providers. For example, for one or more respective financial offers of a financial service provider, the credit management component can track the performance of a financial offer directed to a consumer or group of consumers (e.g., credit or financial group of consumers) relative to other financial offers of other financial service providers directed to the consumer or group of consumers.

At 806, with respect to a financial service provider, the respective performance of the respective financial offers of the financial service provider can be evaluated (e.g., in real or at least near real time) relative to credit groups of consumers (e.g., relative to financial offers to a group of consumers (e.g., financial or credit group of consumers)) and/or relative to same or similar financial offers of other financial service providers. The credit management component can evaluate the respective performances of respective financial offers of the financial service provider relative to credit groups (e.g., a credit group can be a group comprising consumers that meet (e.g., satisfy) a certain defined offer qualification criterion(s)) and relative to same or similar financial offers of other financial service providers at desired times (e.g., evaluation performed in real or near real time (e.g., updating an evaluation as new events relating to the financial offers occur), periodically, dynamically (e.g., in response to a triggering event), etc.). For instance, the credit management component can analyze the financial offers of the financial service provider and other financial service providers to facilitate evaluating the performance of the respective financial offers of the financial service provider relative to the financial offers of other financial service providers. The credit management component can evaluate how the financial offers of the financial service provider have performed relative to the financial offers of other financial service providers, identify respective terms of the offers of the financial service providers, identify the total number of financial offers made by the financial service provider (e.g., over a defined period of time), identify the number of financial offers of the financial service provider that have been selected as a preferred approved financial offer (e.g., over a defined period of time), identify the number of financial offers of the financial service provider that have been accepted by consumers, calculate the ratio of selected offers (e.g., selected as preferred approved financial offer) to the total number of financial offers made by the financial service provider, and/or calculate the ratio of accepted offers (e.g., offer accepted by the consumer) to the total number of financial offers made by the financial service provider. The credit management component also can analyze and evaluate the offer terms (e.g., financial offer parameters) of financial offers of the financial service provider that have underperformed (e.g., not been selected as a preferred approved financial offer, not been accepted by a consumer, etc.) relative to the offer terms of other financial offers of other financial service providers that have performed better (e.g., been selected as a preferred approved financial offer, been accepted by a consumer, etc.) to facilitate determining which offer terms of financial offers of the financial service provider have been causing or at least likely have been causing its offers to underperform, and/or analyze and evaluate the offer terms (e.g., financial offer parameters) of financial offers of the financial service provider that have performed relatively well (e.g., been selected as a preferred approved financial offer, been accepted by a consumer, etc.) relative to the offer terms of other financial offers of other financial service providers to facilitate determining which terms of financial terms of its financial offers are responsible or at least likely responsible for such offers performing well, etc.

At 808, analytics feedback information relating to the financial offers of the financial service provider can be generated (e.g., in real or at least near real time) based at least in part on the results of the evaluation of the financial offers of the financial service provider. The credit management component can generate the analytics feedback information relating to the financial offers of the financial service provider based at least in part on the results of the evaluation. The analytics feedback information can comprise, for example, information identifying the number of financial offers made by the financial service provider (e.g., over a defined time period), information identifying the number of financial offers of the financial service provider that were selected as preferred by the credit management component (e.g., over a defined time period), information identifying the number of financial offers of the financial service provider accepted by a consumer(s) (e.g., over a defined time period), the ratio of selected offers (e.g., selected as preferred approved financial offer) to the total number of financial offers made by the financial service provider, the ratio of accepted offers (e.g., offer accepted by the consumer) to the total number of financial offers made by the financial service provider, information identifying those offer terms of certain financial offers of the financial service provider that have determined to be causing or at least potentially be causing those certain financial offers to underperform, information identifying those offer terms of certain other financial offers that have been determined to be responsible or at least potentially be responsible for those certain other financial offers of the financial service provider performing relatively well, information identifying the one or more financial offer modifications (e.g., modification of terms of financial offers) that can be made to underperforming financial offers to facilitate improving those underperforming financial offers, and/or other analytics feedback information.

At 810, the analytics feedback information relating to the financial offers of the financial service provider can be presented (e.g., in real or at least near real time). The credit management component can present the analytics feedback information to the financial service provider by generating a notification message comprising the analytics feedback information or a notification that the analytics feedback information is available, and transmitting the notification message to the communication device or destination address associated with the financial service provider.

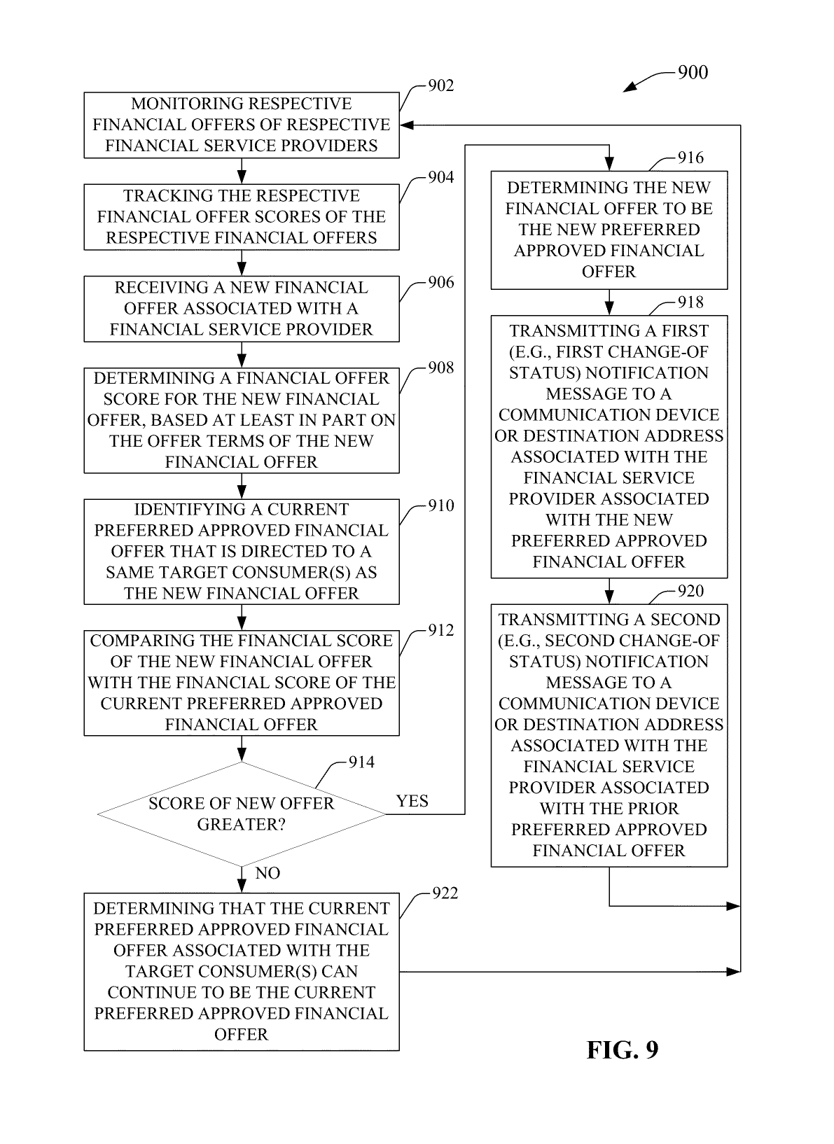

FIG. 9 illustrates a flow chart of an example method 900 that can facilitate notifying (e.g., in real or near real time) a financial service provider of a change of status (e.g., ranking status) of its financial offer, in accordance with various aspects and embodiments of the disclosed subject matter. The method 900 can be utilized, for example, by the open credit exchange platform (e.g., by a credit management component of the open credit exchange platform). The open credit exchange platform can perform all or at least a portion of the operations of the method 900 in real time or at least near real time, automatically, and/or dynamically (e.g., in response to a triggering event occurring).

At 902, respective financial offers (e.g., approved financial offers) of respective financial service providers can be monitored. The credit management component can monitor respective financial offers of respective financial service providers associated with the open credit exchange platform.

At 904, respective financial offer scores of the respective financial offers (e.g., approved financial offers) of the respective financial service providers can be tracked. For each financial offer, when a financial offer is created by a financial service provider and submitted for evaluation and consideration (e.g., consideration to be sent to a consumer(s)) by the open credit exchange platform, the credit management component can evaluate the financial offer and other information relevant to the evaluation and can determine a financial offer score for that financial offer, in accordance with a defined financial offer criterion(s), the offer terms of the financial offer, user preferences of a consumer(s) to which the financial offer is directed, and/or other factors. The credit management component can apply respective score weights or assign respective score values to respective offer terms of the financial offer based at least in part on type of offer term, user preferences of the consumer(s) to which the financial offer is directed, and/or other factors, in accordance with the defined financial offer criterion(s). The credit management component can track the respective financial offer scores of the respective financial offers of the respective financial service providers.

At 906, a new financial offer associated with a financial service provider can be received. The open credit exchange platform can receive a new financial offer from a financial service provider (e.g., as facilitated by a communication device of the financial service provider). The new financial offer can be directed to a target consumer(s) (e.g., directed to one or more specified consumers, directed to a defined credit group (e.g., a group comprising any consumer that satisfies a defined offer qualification criterion(s) (e.g., consumer has a financial health score that satisfies a threshold financial health score) associated with the financial offer).

At 908, a financial offer score can be determined for the new financial offer, based at least in part on the offer terms of the new financial offer, in accordance with the defined financial offer criterion(s). The credit management component can evaluate the terms of the new financial offer and/or other information (e.g., consumer preferences) relevant to the evaluation of the new financial offer, and can determine a financial offer score for the new financial offer based at least in part on the results of the evaluation.

At 910, a current preferred approved financial offer that is directed to a same target consumer(s) as the new financial offer can be identified. The credit management component can identify the target consumer(s) (e.g., subset of consumers to which the new financial offer is directed) associated with the new financial offer, and can identify the current preferred approved financial offer associated with the target consumer(s), based at least in part on the tracking of the financial scores of financial offers. The credit management component can store information that can identify respective target consumers and respectively associated preferred approved financial offers in a look-up table, or can map target consumers to respective preferred approved financial offers. The credit management component can identify the current preferred approved financial offer associated with the target consumer(s) can be identified by referencing the look-up table or the mapping.

At 912, the financial score of the new financial offer can be compared with the financial score of the current preferred approved financial offer. The credit management component can compare the financial score of the new financial offer with the financial score of the current preferred approved financial offer to facilitate determining whether the financial score of the new financial offer is greater than the financial score of the current preferred approved financial offer to thereby make the new financial offer the new preferred approved financial offer.

At 914, a determination can be made regarding whether the financial score of the new financial offer is greater than the financial score of the current preferred approved financial offer. The credit management component can determine whether the financial score of the new financial offer is greater than the financial score of the current preferred approved financial offer based at least in part on the result of the comparison.

At 916, if it is determined that the financial score of the new financial offer is greater than the financial score of the current preferred approved financial offer, the new financial offer can be determined to be the new preferred approved financial offer associated with the target consumer(s). In response to determining that the financial score of the new financial offer is greater than the financial score of the current preferred approved financial offer, the credit management component can determine that the new financial offer is the new preferred approved financial offer associated with the target consumer(s).

At 918, a first notification message can be transmitted to a communication device or destination address associated with the financial service provider associated with the new preferred approved financial offer to facilitate notifying that financial service provider that its new financial offer is the new preferred approved financial offer (e.g., notifying that financial service provider of the change of status of its financial offer). The credit management component can generate the first notification message and transmit it to the communication device or destination address associated with that financial service provider.

At 920, a second notification message can be transmitted to a communication device or destination address associated with the financial service provider associated with the prior preferred approved financial offer to facilitate notifying that financial service provider that its financial offer is no longer the preferred approved financial offer with respect to the target consumer(s) (e.g., notifying that financial service provider of the change of status of its financial offer). The credit management component can generate the second notification message and transmit it to the communication device or destination address associated with such financial service provider.

Referring again to the operation at 914, if it is determined that the financial score of the new financial offer is not greater than the financial score of the current preferred approved financial offer, at 922, it can be determined that the current preferred approved financial offer associated with the target consumer(s) can continue to be the current preferred approved financial offer associated with the target consumer(s). In response to determining that the financial score of the new financial offer is not greater than the financial score of the current preferred approved financial offer, the credit management component can determine that the current preferred approved financial offer associated with the target consumer(s) can continue to be the current preferred approved financial offer.

In some implementations, in response to a determination that the new financial offer is not the new preferred approved financial offer for a target consumer(s), the credit management component can generate a notification message that can be sent to the communication device or destination address associated with the financial service provider that submitted the new financial offer to facilitate notifying that financial service provider that its new financial offer was determined to not be the preferred approved financial offer for the target consumer(s). The notification message also can include information that can make one or more recommendations regarding how the financial service provider can modify its financial offer to better (e.g., beat) the current preferred approved financial offer to become the new preferred approved financial offer. That financial service provider can decide whether to try to submit another financial offer (e.g., a modified financial offer) for that target consumer(s) to try to better the current preferred approved financial offer to become the new preferred approved financial offer.

From the operation at 920 or the operation at 922, the method 900 can return to the operation at 902, and the method 900 can proceed from that point. In some implementations, the credit management component can generate respective analytics of respective financial service providers based at least in part on the results of evaluating events (e.g., change in ranking status of a financial offer, change in number of financial offers made by a financial service provider, change in number of preferred approved financial offers of a financial service provider, etc.) that occurred during an iteration(s) of the method 900. The credit management component can generate respective analytics feedback information, based at least in part on the analytics, and can present the respective analytics feedback information to the respective financial service providers (e.g., via their respective communication devices or destination addresses). The credit management component also can update other information (e.g., information in the look-up table, the mapping, etc.) based at least in part on any events that occurred during an iteration(s) of the method 900.

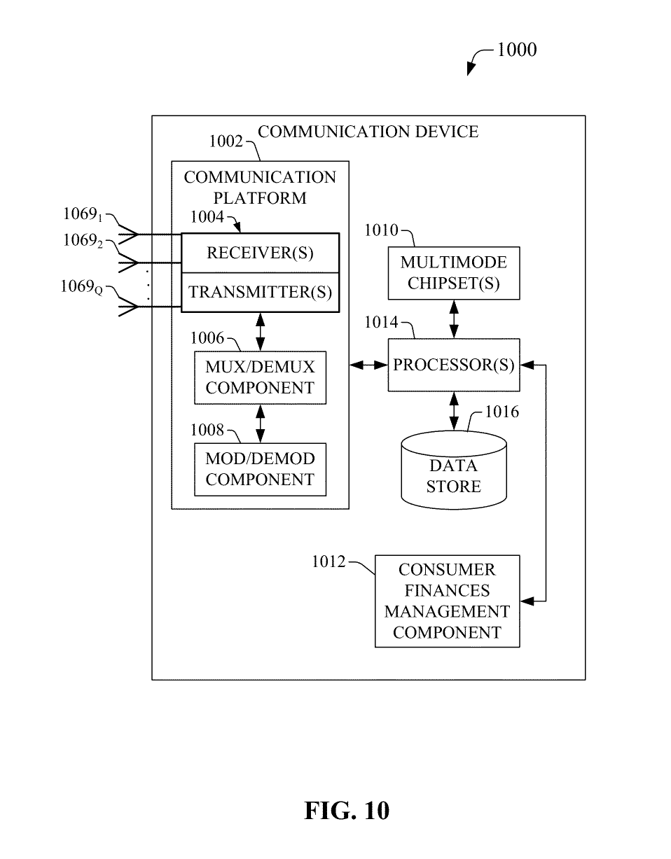

FIG. 10 depicts a block diagram of an example wireless communication device 1000 in accordance with various aspects and embodiments of the disclosed subject matter. In an aspect, the communication device 1000 can be a multimode access terminal, wherein a set of antennas 1069₁-1069_{Q} (Q is a positive integer) can receive and transmit signal(s) from and to wireless devices like access points, access terminals, wireless ports and routers, and so forth, that operate in a radio access network. It should be appreciated that antennas 1069₁-1069_{Q} are a part of communication platform 1002, which comprises electronic components and associated circuitry that provide for processing and manipulation of received signal(s) and signal(s) to be transmitted; e.g., receivers and transmitters 1004, multiplexer/demultiplexer (mux/demux) component 1006, and modulation/demodulation (mod/demod) component 1008.

In another aspect, the communication device 1000 can include a multimode operation chipset(s) 1010 that can allow the communication device 1000 to operate in multiple communication modes in accordance with disparate technical specification for wireless technologies. In an aspect, multimode operation chipset(s) 1010 can utilize communication platform 1002 in accordance with a specific mode of operation (e.g., voice, GPS). In another aspect, multimode operation chipset(s) 1010 can be scheduled to operate concurrently (e.g., when Q>1) in various modes or within a multitask paradigm.

In still another aspect, the communication device 1000 can comprise a consumer finances management component 1012 that can be used to facilitate receiving, reviewing, and/or accepting offers (e.g., approved financial offers) from the open credit exchange program, execute electronic contract documents relating to an approved financial offer, manage a digital wallet and/or finances (e.g., pay debts, transfer monetary funds between accounts, etc.) associated with a consumer, etc., as more fully described herein. The consumer finances management component 1012 can be installed on the communication device 1000 by installing an application, for example.

In still another aspect, the communication device 1000 also can include a processor(s) 1014 that can be configured to confer functionality, at least in part, to substantially any electronic component within the communication device 1000, in accordance with aspects of the disclosed subject matter. For example, the processor(s) 1014 can facilitate enabling the communication device 1000 to process data (e.g., symbols, bits, or chips) for multiplexing/demultiplexing, modulation/demodulation, such as implementing direct and inverse fast Fourier transforms, selection of modulation rates, selection of data packet formats, inter-packet times, etc. As another example, the processor(s) 1014 can facilitate enabling the communication device 1000 to process data relating to managing a digital wallet associated with the consumer, managing finances associated with the consumer, approved financial offers, executing electronic contract documents relating to an approved financial offer, authentication of the consumer or another entity, securing data (e.g., cryptographically securing data) and/or other data processes relating to processing information, including processing financial-related information.

The communication device 1000 also can contain a data store 1016 that can store data structures (e.g., user data, metadata); code structure(s) (e.g., modules, objects, classes, procedures) or instructions; message hashes; information relating to managing a digital wallet associated with the consumer, managing finances associated with the consumer, approved financial offers, executing electronic contract documents relating to an approved financial offer, authentication of the consumer or another entity, securing data, etc.; network or device information like policies and specifications; attachment protocols; code sequences for scrambling, spreading and pilot (e.g., reference signal(s)) transmission; frequency offsets; cell IDs; encoding algorithms; compression algorithms; decoding algorithms; decompression algorithms; and so on. In an aspect, the processor(s) 1014 can be functionally coupled (e.g., through a memory bus) to the data store 1016 in order to store and retrieve information (e.g., information relating to mobile messaging, voice calls, or other services; frequency offsets; desired algorithms; information relating to managing a digital wallet associated with the consumer, managing finances associated with the consumer, approved financial offers, executing electronic contract documents relating to an approved financial offer, authentication of the consumer or another entity, or securing data; etc.) desired to operate and/or confer functionality, at least in part, to the communication platform 1002, multimode operation chipset(s) 1010, consumer finances management component 1012, and/or substantially any other operational aspects of the communication device 1000.

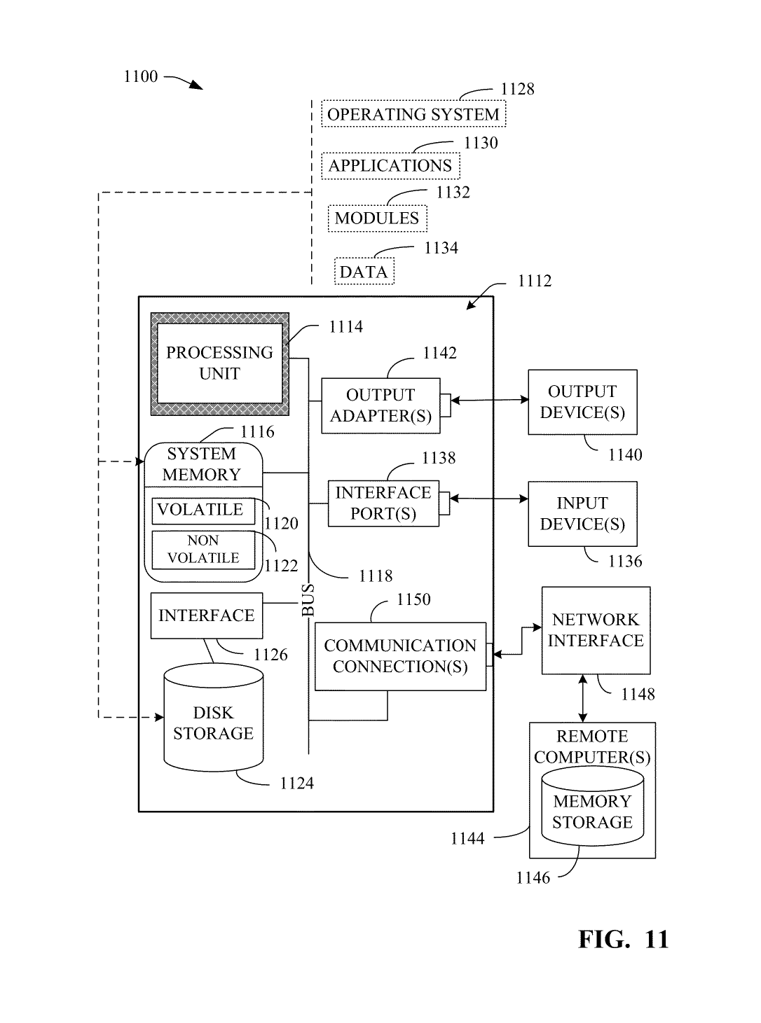

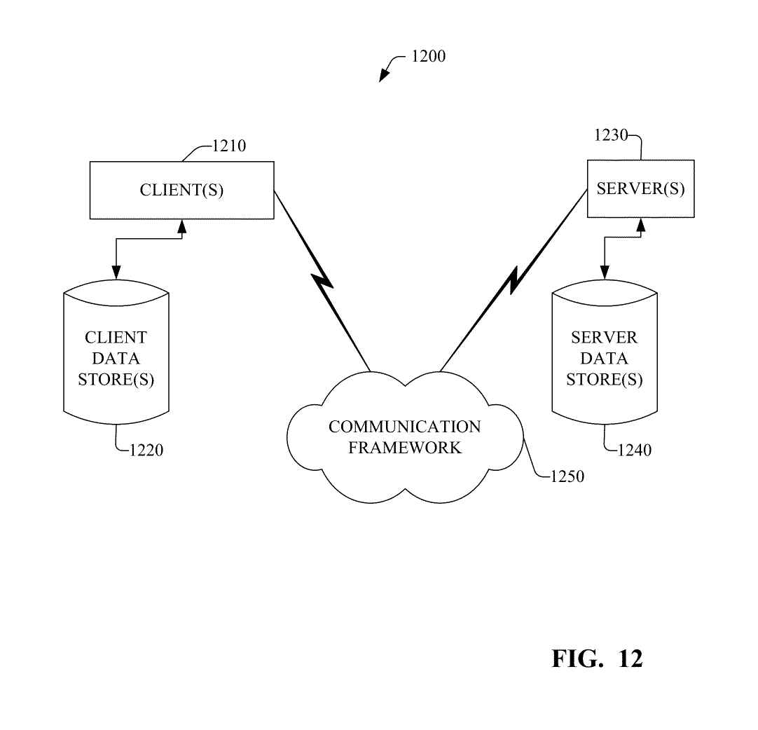

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the disclosed subject matter also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of the disclosed subject matter can be practiced on stand-alone computers. In a distributed computing environment, program modules may be located in both local and remote memory storage devices.

In accordance with various aspects and embodiments, the computer (e.g., 1112) can be, for example, a communication device that can be associated with an open credit exchange platform and can comprise, be associated with, and/or implement various aspects and/or functions of the open credit exchange platform; a communication device that can be associated with a financial service provider and can comprise, be associated with, and/or implement various aspects and/or functions of an FSP credit management component; or a communication device that can be associated with a consumer and can comprise, be associated with, and/or implement various aspects and/or functions of the consumer finances management component.

With reference to FIG. 11, a suitable environment 1100 for implementing various aspects of the disclosed subject matter includes a computer 1112. The computer 1112 includes a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable programmable ROM (EEPROM), or flash memory. Volatile memory 1120 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable programmable ROM (EEPROM), or flash memory. Volatile memory 1120 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable programmable ROM (EEPROM), or flash memory. Volatile memory 1120 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable programmable ROM (EEPROM), or flash memory. Volatile memory 1120 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1112 also includes removable/non-removable, volatile/non-volatile computer storage media. FIG. 11 illustrates, for example, a disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used, such as interface 1126.

It is to be appreciated that FIG. 11 describes software that acts as an intermediary between users and the basic computer resources described in the suitable operating environment 1100. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that the claimed subject matter can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers, among other output devices 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

FIG. 12 is a schematic block diagram of a sample-computing environment 1200 with which the subject specification can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the disclosed subject matter, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1220 that can be employed to store information local to the client(s) 1210. Similarly, the server(s) 1230 are operatively connected to one or more server data store(s) 1240 that can be employed to store information local to the servers 1230.

It is to be appreciated and understood that components (e.g., open credit exchange platform, credit management component, communication device, FSP credit management component, consumer finances management component, communication network, etc.), as described with regard to a particular system or method, can include the same or similar functionality as respective components (e.g., respectively named components or similarly named components) as described with regard to other systems or methods disclosed herein.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “mobile station,” “mobile,” “wireless device,” “wireless communication device,” “access terminal,” “terminal,” and similar terminology are used herein to refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the term “access point” (AP), can be or can comprise a base station, Node B, Evolved Node B (eNode B or eNB), Home Node B (HNB), home access point (HAP), and can refer to a wireless network component or appliance that serves and receives data, control, voice, video, sound, gaming, or substantially any data-stream or signaling-stream from a set of subscriber stations. Data and signaling streams can be packetized or frame-based flows.

Furthermore, the terms “user,” “subscriber,” and the like are employed interchangeably throughout the subject specification, unless context warrants particular distinction(s) among the terms. It should be appreciated that such terms can refer to human entities or automated components supported through artificial intelligence (e.g., a capacity to make inference based on complex mathematical formalisms), which can provide simulated vision, sound recognition and so forth.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be noted that aspects, features, and/or advantages of the disclosed subject matter can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and flash memory devices (e.g., card, stick, key drive, etc.), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” “data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a memory to store computer-executable components; and
a processor, coupled to the memory, that executes or facilitates execution of at least one of the computer-executable components, the computer-executable components comprising:
an open credit exchange component that is associated with a set of financial service provider identities and a set of consumer identities, and facilitates evaluation of a performance of a set of approved financial offers of a financial service provider identity of the set of financial service provider identities, wherein the set of approved financial offers are directed to one or more consumer identities of the set of identities; and
a credit management component that generates performance analytics relating to the subset of approved financial offers of the financial service provider identity based at least in part on a result of the evaluation of the performance of the subset of approved financial offers, and presents analytics feedback information comprising information relating to the performance analytics associated with the subset of approved financial offers to a communication device or a destination address associated with the financial service provider identity.

2. The system of claim 1, wherein the credit management component evaluates the performance of the set of approved financial offers of the financial service provider relative to other approved financial offers of other financial service provider identities of the set of financial service provider identities to facilitate the generation of the performance analytics.

3. The system of claim 2, wherein the open credit exchange platform and the credit management component operate in an always-on operating environment that facilitates updating information relating to the performance of the set of approved financial offers in real time by the credit management component.

4. The system of claim 1, wherein the performance analytics relate to at least one of a ratio of approved financial offers selected as preferred to total approved financial offers presented over a defined time period, a ratio of approved financial offers accepted by one or more consumer identities to total approved financial offers presented over a defined time period, respective performance of respective offer terms of approved financial offers in the set of approved financial offers, performance of the set of approved financial offers of the financial service provider identity relative to performance of other approved financial offers of other financial service provider identities, performance of the set of approved financial offers of the financial service provider identity relative to respective credit groups of consumer identities, information that identifies a first subset of the respective offer terms that are determined to be underperforming and a second subset of the respective offer terms that are determined to be performing well in accordance with a defined financial offer criterion relating to performance of offer terms, or a recommendation regarding modification of an approved financial offer of the set of approved financial offers that has been determined to be underperforming to facilitate improving performance of the approved financial offer.

5. The system of claim 1, wherein the credit management component presents the analytics feedback information via one or more interfaces associated with the open credit exchange component.

6. The system of claim 5, wherein the credit management component generates one or more visual representations of or relating to the analytics feedback information, and presents the one or more visual representations of or relating to the analytics feedback information to the communication device or the destination address associated with the financial service provider identity, wherein the one or more visual representations comprise at least one of a chart, a graph, a table, a dashboard, or a meter.

7. The system of claim 5, wherein the credit management component presents, via the one or more interfaces, a set of modification controls that facilitate example modification of an approved financial offer of the set of approved financial offers in response to manipulation of the set of modification controls via the communication device, and determines and presents predicted performance analytics that indicate an example predicted performance of the example modification of the approved financial offer.

8. The system of claim 1, wherein the credit management component tracks respective approved financial offers of respective financial service provider identities of the set of financial service provider identities to facilitate determining a change in status of one or more of the respective approved financial offers.

9. The system of claim 8, wherein, in response to receipt of a new approved financial offer of the financial service provider identity that is directed to at least one consumer identity, the credit management component determines a financial offer score for the new approved financial offer and compares the financial offer score associated with the new approved financial offer to a financial offer score associated with a current preferred approved financial offer that is directed to the at least one consumer identity.

10. The system of claim 9, wherein the credit management component determines whether the financial offer score associated with the new approved financial offer is greater than the financial offer score associated with the current preferred approved financial offer based at least in part on a result of the comparison of the financial offer score associated with the new approved financial offer to the financial offer score associated with the current preferred approved financial offer.

11. The system of claim 10, wherein, in response to determining that the financial offer score associated with the new approved financial offer is greater than the financial offer score associated with the current preferred approved financial offer, the credit management component determines that the new approved financial offer is a new preferred approved financial offer in connection with the at least one consumer identity, and at least one of communicates a first notification message to the communication device or the destination address associated with the financial service provider identity or communicates a second notification message to a second communication device or a second destination address associated with a second financial service provider identity associated with the approved financial offer that previously had been the current preferred approved financial offer, wherein the first notification message facilitates notifying the financial service provider identity that the new approved financial offer is the new preferred approved financial offer, and the second notification message facilitates notifying the second financial service provider identity that its approved financial offer, which previously had been the current preferred approved financial offer, is no longer a preferred approved financial offer in connection with the at least one consumer identity.

12. The system of claim 10, wherein, in response to determining that the financial offer score associated with the new approved financial offer is not greater than the financial offer score associated with the current preferred approved financial offer, the credit management component determines that the new approved financial offer is not a preferred approved financial offer in connection with the at least one consumer identity, and at least one of communicates a first notification message to the communication device or the destination address associated with the financial service provider identity or communicates a second notification message to a second communication device or a second destination address associated with a second financial service provider identity associated with the current preferred approved financial offer, wherein the first notification message facilitates notifying the financial service provider identity that the new approved financial offer is not the preferred approved financial offer, and the second notification message facilitates notifying the second financial service provider identity that its current preferred approved financial offer continues to be the preferred approved financial offer in connection with the at least one consumer identity.

13. The system of claim 1, wherein the credit management component determines a set of standardized financial offer parameters, in accordance with a defined financial offer criterion, and presents the set of standardized financial offer parameters to the communication device associated with the financial service provider identity to facilitate standardized generation of an approved financial offer that comprises a subset of standardized financial offer parameters of the set of standardized financial offer parameters.

14. The system of claim 13, wherein the credit management component presents the set of standardized financial offer parameters via at least one of a list or a menu.

15. The system of claim 13, wherein the set of standardized financial offer parameters comprises a first subset of standardized financial offer parameters and a second subset of standardized financial offer parameters, and the first subset of standardized financial offer parameters relates to a first type of financial offer term associated with a type of approved financial offer and the second subset of standardized financial offer parameters relates to a second type of financial offer term associated with the type of approved financial offer.

16. The system of claim 1, wherein the credit management component manages registration and participation of respective financial service provider identities of the set of financial service provider identities with a credit exchange associated with the open credit exchange component in part by enforcement of a set of defined conditions for participation in the credit exchange.

17. The system of claim 16, wherein, as part of a registration of the financial service provider identity with the credit exchange, the credit management component requests registration information from the financial service provider identity, evaluates the registration information in connection with the set of defined conditions, determines whether the financial service provider identity satisfies the set of defined conditions based at least in part on the evaluation of the registration information, and, in response to determining that the financial service provider identity satisfies the set of defined conditions, registers the financial service provider identity with the credit exchange and grants a set of access rights to the financial service provider identity to enable the financial service provider identity to access the open credit exchange component.

18. A method, comprising:
generating, by a system comprising a processor, financial-offer performance analytics relating to a set of pre-approved financial offers of a financial service provider identity based at least in part on a result of an evaluation of a performance of the set of pre-approved financial offers; and
presenting, by the system, analytics feedback information comprising information relating to the financial-offer performance analytics associated with the set of pre-approved financial offers to a communication device or a destination address associated with the financial service provider identity.

19. The method of claim 18, further comprising:
evaluating, by the system, the performance of the set of approved financial offers of the financial service provider relative to other approved financial offers of other financial service provider identities of the set of financial service provider identities to facilitate the generating of the performance analytics.

20. The method of claim 18, further comprising:
presenting, by the system, the analytics feedback information via one or more interfaces.

21. The method of claim 20, further comprising:
generating, by the system, one or more visual illustrations of or relating to the analytics feedback information, and presents the one or more visual illustrations of or relating to the analytics feedback information to the communication device or the destination address associated with the financial service provider identity, wherein the one or more visual illustrations comprise at least one of a chart, a graph, a table, a dashboard, or a meter.

22. The method of claim 20, further comprising:
presenting, by the system, via the one or more interfaces, a set of modification controls that facilitate example modification of an approved financial offer of the set of approved financial offers in response to manipulating the set of modification controls via the communication device; and
determining, by the system, predicted performance analytics that indicate an example predicted performance of the example modification of the approved financial offer; and
presenting, by the system, the predicted performance analytics to the communication device.

23. The method of claim 18, further comprising:
tracking, by the system, respective approved financial offers of respective financial service provider identities of the set of financial service provider identities to facilitate determining a change in status of one or more of the respective approved financial offers, in an always-on operating environment that facilitates updating performance information relating to the performance of the set of approved financial offers in real time; and
updating, by the system, performance information relating to the performance of the set of approved financial offers in real time based at least in part on the tracking of the respective approved financial offers of the respective financial service provider identities.

24. The method of claim 23, further comprising:
in response to receipt of a new approved financial offer of the financial service provider identity that is directed to at least one consumer identity,
determining, by the system, a financial offer score for the new approved financial offer; and
comparing, by the system, the financial offer score associated with the new approved financial offer to a financial offer score associated with a current preferred approved financial offer that is directed to the at least one consumer identity.

25. The method of claim 24, further comprising:
determining, by the system, whether the financial offer score associated with the new approved financial offer is greater than the financial offer score associated with the current preferred approved financial offer based at least in part on a result of the comparing of the financial offer score associated with the new approved financial offer to the financial offer score associated with the current preferred approved financial offer.

26. The method of claim 25, further comprising:
in response to determining that the financial offer score associated with the new approved financial offer is greater than the financial offer score associated with the current preferred approved financial offer,
determining, by the system, that the new approved financial offer is a new preferred approved financial offer in connection with the at least one consumer identity; and
at least one of:
communicating, by the system, a first notification message to the communication device or the destination address associated with the financial service provider identity, or
communicating, by the system, a second notification message to a second communication device or a second destination address associated with a second financial service provider identity associated with the approved financial offer that previously had been the current preferred approved financial offer, wherein the first notification message facilitates notifying the financial service provider identity that the new approved financial offer is the new preferred approved financial offer, and the second notification message facilitates notifying the second financial service provider identity that its approved financial offer, which previously had been the current preferred approved financial offer, is no longer a preferred approved financial offer in connection with the at least one consumer identity.

27. The method of claim 25, further comprising:
in response to determining that the financial offer score associated with the new approved financial offer is not greater than the financial offer score associated with the current preferred approved financial offer,
determining, by the system, that the new approved financial offer is not a preferred approved financial offer in connection with the at least one consumer identity; and
at least one of:
communicating, by the system, a first notification message to the communication device or the destination address associated with the financial service provider identity, or
communicating, by the system, a second notification message to a second communication device or a second destination address associated with a second financial service provider identity associated with the current preferred approved financial offer, wherein the first notification message facilitates notifying the financial service provider identity that the new approved financial offer is not the preferred approved financial offer, and the second notification message facilitates notifying the second financial service provider identity that its current preferred approved financial offer continues to be the preferred approved financial offer in connection with the at least one consumer identity.

28. The method of claim 18, further comprising:
determining, by the system, a set of standardized financial offer parameters, in accordance with a defined financial offer criterion; and
presenting, by the system, the set of standardized financial offer parameters to the communication device associated with the financial service provider identity to facilitate standardized generation of an approved financial offer that comprises a subset of standardized financial offer parameters of the set of standardized financial offer parameters.

29. The method of claim 18, further comprising:
requesting, by the system, registration information from the financial service provider identity to facilitate registering the financial service provider identity with the credit exchange;
evaluating, by the system, the registration information in connection with a set of defined conditions relating to registration with and participation in a credit exchange by financial service provider identities;
enforcing, by the system, the set of defined conditions;
determining, by the system, whether the financial service provider identity satisfies the set of defined conditions based at least in part on the evaluation of the registration information; and
in response to determining that the financial service provider identity satisfies the set of defined conditions,
registering, by the system, the financial service provider identity with the credit exchange, and
granting a set of access rights to the financial service provider identity to enable the financial service provider identity to access the credit exchange.

30. A computer-readable storage device storing computer-executable instructions that, in response to execution, cause a system comprising a processor to perform operations, comprising:
generating financial-offer performance analytics relating to a set of approved financial offers of a financial service provider identity based at least in part on a result of an evaluation of a performance of the set of approved financial offers; and
communicating analytics feedback information comprising information relating to the financial-offer performance analytics associated with the set of approved financial offers to a communication device or a destination address associated with the financial service provider identity.

31. The computer-readable storage device of claim 30, wherein the operations further comprise:
tracking the set of approved financial offers of the financial service provider identity and other approved financial offers of other financial service provider identities of the set of financial service provider identities to facilitate determining a change in status of one or more of an approved financial offer of the set of approved financial offers or other approved financial offers of the other financial service provider identities, in an always-on operating environment that facilitates updating performance information relating to the performance of the set of approved financial offers or the other approved financial offers in real time;
evaluating the performance of the set of approved financial offers of the financial service provider relative to the other approved financial offers of the other financial service provider identities, based at least in part on the performance information, to facilitate the generating of the performance analytics; and
determining whether there is a change in status of one or more of the approved financial offer of the set of approved financial offers or the other approved financial offers of the other financial service provider identities, based at least in part on a result of the evaluating of the performance.
